(19) United States
(12) Patent Application Publication
(10) Pub. No.: US 2023/0269080 A1
(43) Pub. Date: Aug. 24, 2023

(54) PROVIDER AND RECEIVER CRYPTOSYSTEMS COMPRISING COMBINED ALGORITHMS

(71) Applicant: Bundesdruckerei GmbH, Berlin (DE)

(72) Inventors: Klaus-Dieter WIRTH, Berlin (DE); Frank BYSZIO-WEGENER, Wandlitz (DE)

(73) Assignee: Bundesdruckerei GmbH, Berlin (DE)

(21) Appl. No.: 18/004,100

(22) PCT Filed: Jul. 7, 2021
(86) PCT No.: PCT/EP2021/068805

§ 371 Date: Jan. 3, 2023

(30) Foreign Application Priority Data
Jul. 8, 2020 (DE) 10 2020 117 999.5

(51) Int. Cl. H04L 9/16; H04L 9/08; H04L 9/32

(52) U.S. Cl. CPC H04L 9/16; H04L 9/0838; H04L 9/3247; H04L 9/0825

(57) ABSTRACT

In one embodiment, the method includes computing composite cryptographic data by executing a plurality of first cryptographic algorithms, wherein the composite cryptographic data are computed as a function of input data, wherein the plurality of first cryptographic algorithms are selected and/or the plurality of first cryptographic algorithms are combined according to a first control algorithm; computing results data using a receiver cryptosystem as a function of the composite cryptographic data by applying one or more of the second cryptographic algorithms, wherein the one or more second cryptographic algorithms are selected and/or combined according to a second control algorithm; and automatically executing a software and/or hardware function using the receiver cryptosystem according to the results data.

### FIELD

The invention relates to a method and system for exchanging data between two cryptographic systems using an asymmetric cryptographic algorithm.

### BACKGROUND

Asymmetric cryptographic algorithms, also referred to as asymmetric cryptographic procedures, consist of two functionally complementary cryptographic algorithms to be executed by the participants in the procedure, such as encryption and decryption, signing and signature verification, and key agreement procedures. These types of procedure are indispensable for security-related IT applications. At the same time, only few asymmetric cryptographic procedures are currently in practical use. This is probably at least partly due to the fact that asymmetric cryptographic procedures often have a plurality of organisationally independent participants. All participants must support a specific asymmetric cryptographic procedure (for example RSA, DSA (Digital Signature Algorithm) or DH (Diffie Hellmann) and expect an algorithm designator of the procedure used by the other participant to generate the provided cryptographic data at a defined location within highly standardised data structures such as X.509 certificates.

The cryptographic strength of many of the algorithms used today—and thus the security of IT-based applications that use these algorithms—is threatened by the availability of powerful quantum computers expected in the next few years. New asymmetric cryptographic methods are currently being developed that are also expected to be able to withstand the computing power of quantum computers.

In view of the large number of different and interdependent applications that use asymmetric cryptographic procedures (for example to check the integrity or origin of a message or to cryptographically secure data and data transmission channels), it is becoming apparent, however, that the conversion of existing IT applications and systems to new, quantum-secure procedures will cause problems. This is because IT systems based on asymmetric cryptographic algorithms are mostly multi-participant systems, wherein the various participants may belong to different organisations and/or may be based on different software and/or hardware architectures. Converting one or more participants in such a system to quantum-secure asymmetric cryptographic algorithms will therefore have the effect that participants who are unable switch over to the new procedures quickly enough for technical and/or organisational reasons will no longer be compatible with the participants who have already switched over. For example, in the future it may be necessary to make the cryptographic keys used to establish an encrypted transmission channel (for example for SSH and/or TLS) quantum-secure. Given the large number and heterogeneity of client computer systems to which a server computer system may need to establish a protected channel, it is foreseeable that a concerted conversion of such algorithms will pose a major technical problem.

In a few years, however, there will be a large number of asymmetric cryptographic algorithms that were considered secure at the time of their development but are then no longer strong enough to provide the required level of security.

An attempt to solve the problem of upgrading cryptographic systems to quantum-secure methods by embedding alternative sets of cryptographic materials in digital X.509v3 certificates is known (“Multiple Public-Key Algorithm X.509 Certificates”, 2018, A. Truskovsky, P. Lafrance, D. Van Geest, S. Fluhrer, P. Kampanakis, M. Ounsworth, S. Mister). The embedded alternative cryptographic materials allow a Public Key Infrastructure (PKI) to use a plurality of cryptographic algorithms in a single object and allow the transition to the new cryptographic algorithms while maintaining backward compatibility with systems using the existing algorithms. This method uses X.509 extensions to incorporate the additional material in the certificates.

One problem with this approach, however, is the need to rewrite the software used to perform the cryptographic operations, because the additional cryptographic data are no longer contained in the fields where the participants previously expected to find these data according to established cryptographic standards. Furthermore, the approach is limited to X.509 certificates and requires the definition of certificate verifications for these certificates.

### SUMMARY

The object of the invention is to create an improved method and system for exchanging data between a provider cryptosystem and a receiver cryptosystem. The objects forming the basis of the invention are achieved by the features of the independent claims. Embodiments of the invention are described in the dependent claims. The embodiments described in the following are freely combinable with each other unless they are mutually exclusive.

In one aspect, the invention relates to a method for exchanging data between a provider cryptosystem and a receiver cryptosystem. The method comprises the steps of:
computing composite cryptographic data by executing a plurality of the first cryptographic algorithms, wherein the composite cryptographic data are computed as a function of the input data, wherein the plurality of first cryptographic algorithms and/or a combination of the plurality of first cryptographic algorithms are selected according to a first control algorithm;
providing the composite cryptographic data from the provider cryptosystem to the receiver cryptosystem;
computing results data using the receiver cryptosystem as a function of the composite cryptographic data by applying one or more of the second cryptographic algorithms, wherein the one or more second cryptographic algorithms are selected and/or combined according to a second control algorithm; and
automatically executing a software and/or hardware function using the receiver cryptosystem according to the results data.

The input data may be, for example, a data value, a data set, a key, part of a key, a message, part of the message, or a value derived from the data value, data set, key, message or part of the message (for example a hash value of the message).

The results data may be, for example, a reconstructed copy of at least parts of the input data, a result of a signature verification, a mutually agreed or random key, or the like.

The composite cryptographic data may be provided, for example, directly via an interface between the two cryptosystems, for example by the provider cryptosystem generating a message containing the composite cryptographic data and transmitting same to the receiver cryptosystem, for example via a network, for example the Internet.

Alternatively, the provider cryptosystem may provide the composite cryptographic data indirectly, for example by storing the composite cryptographic data in a storage medium readable by the receiver cryptosystem. For example, the data may be stored in a database, such as an archive. The receiver cryptosystem then reads the composite cryptographic data from the database.

Usually, the provider cryptosystem and the receiver cryptosystem are different cryptosystems. However, it is also possible according to some embodiments that the provider cryptosystem and the receiver cryptosystem are identical. For example, the provider cryptosystem may generate the composite cryptographic data initially by encrypting input data and storing same in a database. At a later point in time, possibly after years, the same cryptosystem reads these data again in its function as a receiver cryptosystem and must decrypt the data again.

For example, embodiments of the invention may be used to make RSA cryptosystems quantum-computer-secure. RSA is an asymmetric cryptographic method that may be used by RSA cryptosystems for both encryption and digital signing. It uses a key pair consisting of a private key, which is used to decrypt or sign data, and a public key, which is used to encrypt or verify signatures. The private key is kept secret and is unable to be computed from the public key. The security of the RSA method is substantially based on the difficulty of factorising large numbers. This security is challenged by the advent of quantum computers, and therefore embodiments of the invention may be employed to use RSA algorithms as first and/or second cryptographic algorithms together with other quantum-computer-secure algorithms to generate or process composite cryptographic signatures.

Similarly, embodiments of the invention may also be employed to replace algorithms such as DSA and DH, the security of which is based on the difficulty of finding the discrete logarithm, and the algorithms ECDSA and ECDH, the security of which is based on the difficulty of finding the discrete logarithm on elliptic curves, with quantum-computer-secure algorithms.

In some embodiments, the provider cryptosystem provides only the composite cryptographic data and preferably also an identifier of the second control algorithm and optionally parameters for performing the second control algorithm. In other embodiments, further data are also provided additionally. For example, the composite cryptographic data may be a composite signature of a message. In this case, the electronic document for which the signature was generated is preferably provided in addition to the composite signature.

Embodiments of the invention may have the advantage that both the provider cryptosystem and the receiver cryptosystem are highly flexible. Both on the provider cryptosystem and on the receiver cryptosystem, a plurality of algorithms, for example each functionally complementary, belonging to different asymmetric cryptographic methods may be implemented. These are now selected and/or combined according to the specifications in the first and second control algorithms, respectively, in order to generate the composite cryptographic data. The composite cryptographic data may thus comprise the results of two or more different first cryptographic algorithms. This may mean, for example, that the composite cryptographic data contain a plurality of digital signatures generated for the same electronic document using different signature algorithms (first cryptographic algorithms). The transmission of such a composite signature to the receiver system has the advantage that at least if the receiver system supports at least one signature verification algorithm corresponding to a signature generation algorithm used to generate the composite signature, the receiver system may already be able to verify the signature. Analogously, the composite cryptographic data may also be a composite encrypted data set generated by encrypting input data using a plurality of cryptographic keys (in parallel or sequentially), or a communication key generated by combining a plurality of user-specific key agreement algorithms. Since the transmitted composite cryptographic data are composed of the cryptographic output of two or more different first cryptographic algorithms, the information content of the transmitted data is higher than if only the output of an individual cryptographic algorithm were transmitted. This allows the receiver cryptosystem to respond in a very flexible way. For example, if the security requirements for a particular application are very high, the second control algorithm may be specified in such a way that a plurality of second cryptographic algorithms must necessarily be successfully applied to the received composite cryptographic data in order to obtain a correct result or confirmation of the integrity of the signed document.

According to embodiments, the first control algorithm specifies a selection and/or sequence of first cryptographic algorithms that is functionally complementary to the selection and/or sequence of the one or more second cryptographic algorithms specified in the second control algorithm.

For example, the provider cryptosystem may include a plurality of encryption algorithms V1-V10. The receiver cryptosystem may include a plurality of decryption algorithms E1-E10, each of which is complementary to the corresponding encryption algorithms. For example, E1 may decrypt a ciphertext formed by V1, E2 may decrypt a ciphertext formed by V2, etc. For example, the first control algorithm specifies a sequence of three encryption algorithms V1, V2, V3, which are iteratively applied to the input data according to the first control algorithm as follows: V1 (input data)=output1; V2 (output1)=output2; V3 (output2)=output3=composite cryptographic data. A second control algorithm functionally complementary to this first control algorithm would specify a sequence of three functionally complementary decryption algorithms E1, E2, E3 applied iteratively to the composite cryptographic data as follows: E3 (composite cryptographic data)=decrypted data1; E2 (decrypted data1)=decrypted data2; E1 (decrypted data2)=decrypted data3=reconstructed input data.

Instead of iterative encryption, the individual encryption algorithms may also be applied in parallel so that the composite cryptographic data may be formed, for example, as a concatenation of the individual ciphertexts. In this case, the second control algorithm could identify one or more decryption keys, which are then applied to the corresponding ciphertext in such a combined manner that the original input data or parts thereof are reconstructed.

According to embodiments of the invention, the provider cryptosystem implements a plurality of first control algorithms.

In addition or alternatively, the receiver cryptosystem implements a plurality of second control algorithms.

A large number of first and/or second control algorithms may be advantageous, as this allows a very flexible way of agreeing between the provider and receiver cryptosystems which cryptographic algorithms to apply in which sequence in order to perform the data exchange in a desired manner. In particular, according to embodiments of the invention, it may no longer be necessary to modify source code on the provider side or receiver side to change the creation and/or processing of the composite cryptographic data. Such changes may be required for a variety of reasons. For example, it may turn out that a particular cryptographic algorithm is no longer secure enough or is technically problematic for other reasons. In this case, it is possible to change within the first control algorithm only one algorithm designator of the first cryptographic algorithms used in the creation of the composite cryptographic data. Preferably, the first and/or second control algorithms are in the form of editable instructions, for example as a script file, rule or configuration file. It is also possible that the first control algorithm for generating the composite cryptographic data uses a larger number of first cryptographic algorithms than the second control algorithm for processing these data. This may have the advantage that a plurality of different first cryptographic algorithms of the same procedure type (for example, a plurality of different signature algorithms or a plurality of different encryption algorithms or a plurality of different provider-side key agreement algorithms) are used to generate the composite cryptographic data. At least if the different first algorithms are used in parallel, it may be sufficient that a single second cryptographic algorithm capable of correctly processing at least part of the composite cryptographic data is specified in the second control algorithm.

This makes it possible for different receiver cryptosystems to operate with different security levels and possibly also different second cryptographic algorithms on the basis of the same composite cryptographic data. The greater the number of first algorithms supported by the first cryptosystem and/or used to form the composite cryptographic data, the greater the likelihood that the receiver cryptosystem is able to correctly process the composite cryptographic data or at least part of it. This also facilitates the large-scale conversion to quantum-safe cryptographic algorithms affecting many participants, because the composite cryptographic data may contain partial data generated using secure procedures that are unable to be cracked even by quantum computers, even if these procedures are not yet available on some receiver cryptosystems, because these receiver systems have the option of using those partial data of the composite cryptographic data that were generated using the obsolete and possibly no longer sufficiently secure cryptographic procedure. Thus, different participants with different security levels may coexist and be used together without the need to simultaneously bring all participants to a uniform security level based on a uniform procedure.

According to embodiments, at least one of the first cryptographic algorithms is an algorithm for encryption, signing, or key agreement. At least one of the one or more second cryptographic algorithms is a decryption, signature verification, and key agreement algorithm complementary to the at least one first cryptographic algorithm.

Additionally or alternatively, each of the first cryptographic algorithms is assigned an algorithm designator (also “algorithm identifier”).

According to embodiments, the provider cryptosystem is configured to provide the composite cryptographic data together with parameters for the execution of the second control algorithm.

According to embodiments of the invention, the parameters for the execution of the second control algorithm comprise algorithm designators of the second cryptographic algorithms to be used for processing the composite cryptographic data by the second control algorithm. For example, the algorithm designators of the second cryptographic algorithms may be identical to the algorithm designators of the first cryptographic algorithms used to generate the composite cryptographic data. For example, the algorithm designator of the “RSA” method may be used both by the first control algorithm to identify a first cryptographic algorithm that implements the provider-side steps of the RSA method and by the second control algorithm to identify a second cryptographic algorithm that implements the receiver-side steps of the RSA method.

According to embodiments of the invention, the parameters for the execution of the second control algorithm comprise one or more parameters which control the individual second cryptographic algorithms and are transferred, for example, as arguments of these second cryptographic algorithms. These parameters are hereinafter also referred to as “component parameters”. Depending on the cryptographic method, the component parameters may be identical or different to the component parameters used by the corresponding first cryptographic algorithms.

In some embodiments, the parameters for the execution of the second control algorithm further comprise input parameters for the second control algorithm that are used directly by the second control algorithm, i.e. do not serve as input parameters of individual second cryptographic algorithms. These parameters, which directly control the execution of the second control algorithm, are called control parameters in the following. The control parameters may, for example, specify the minimum number of second cryptographic algorithms that must be successfully executed for the result obtained to be considered valid.

According to embodiments, the second control algorithm is configured to select the second cryptographic algorithm(s) used for computing the results data, each based on an algorithm designator contained in the parameters.

Preferably, the algorithm designator of the first and second cryptographic algorithms, which are functionally complementary to each other, is identical and denotes an asymmetric cryptographic method of which the first cryptographic algorithm implements the provider-side steps and of which the second cryptographic algorithm implements the receiver-side steps.

According to embodiments of the invention, the algorithm designators of the first and second cryptographic algorithms are each selected from a group comprising:
an algorithm designator of a key agreement algorithm between a first and a second user system, wherein the first cryptographic algorithm identified by the algorithm designator implements the key agreement steps performed by the first user system, and wherein the functionally complementary second cryptographic algorithm implements the key agreement steps performed by the second user system;
an algorithm designator of an asymmetric cryptographic algorithm for encrypted transmission from a first user system to a second user system, wherein the first cryptographic algorithm identified by the algorithm designator implements the steps performed by the first user system to encrypt data into a ciphertext, and wherein the functionally complementary second cryptographic algorithm implements the ciphertext decryption steps performed by the second user system;
an algorithm designator of an asymmetric cryptographic algorithm for generating a digital signature by a first user system and for verifying this signature by a second user system, wherein the first cryptographic algorithm identified by the algorithm designator implements the signature generation steps performed by the first user system, and wherein the functionally complementary second cryptographic algorithm implements the signature verification steps performed by the second user system.

The three types of algorithms mentioned above are among the most important algorithms of distributed cryptographic systems. They all include at least some algorithms which are expected to be classified as insecure in the near future. Embodiments of the invention may thus support a large number of different cryptosystems and their conversion to other, potentially more secure cryptographic algorithms.

According to embodiments, the first control algorithm specifies that the plurality of first cryptographic algorithms are in each case applied sequentially to the output of the previously executed first cryptographic algorithm. Alternatively, the first control algorithm may specify that the plurality of first cryptographic algorithms are applied in parallel to the input data or parts of the input data. It is possible for the provider cryptosystem to include a plurality of first control algorithms, some of which provide for parallel execution and others of which provide for sequential execution of a plurality of first cryptographic algorithms.

According to embodiments, the second control algorithm specifies that the plurality of second cryptographic algorithms are in each case sequentially applied to the output of the previously executed second cryptographic algorithm, or that the plurality of second cryptographic algorithms are applied in parallel to the composite cryptographic data or parts of the composite cryptographic data.

Sequential execution of algorithms may be advantageous in application scenarios where a particularly high level of security is required. This is because both the provider side and the receiver side must support and execute a plurality of cryptographic algorithms at the same time in order to correctly transform input data into the composite cryptographic data or to reconstruct or verify these input data using the composite cryptographic data. Parallel execution of algorithms may be advantageous in application scenarios where compatibility is to be established with a large number of heterogeneous receiver systems that support possibly different algorithms of the same type. This is because, when the first cryptographic algorithms are used in parallel, the composite cryptographic data preferably comprise partial data, which may each be processed individually by a corresponding cryptographic algorithm, regardless of whether the receiver system supports all of the second cryptographic algorithms that would be required to process all of these partial data. This may have the advantage of providing a particularly flexibly adaptable data exchange procedure for cryptosystems for a wide range of applications and security requirements.

According to embodiments, the second control algorithm is an algorithm complementary to the first control algorithm, specifying that the plurality of second cryptographic algorithms are to be applied in a functionally complementary sequential or parallel manner to the composite cryptographic data and/or output of the previously applied second algorithm as specified in the first control algorithm. For example, the first control algorithm may provide for sequential application of the first encryption algorithms V1, V2 and V3 and the second control algorithm may provide for sequential application of the corresponding decryption algorithms E3, E2 and E1.

According to embodiments of the invention, at least the first control algorithm contains Boolean operators and/or arithmetic operators that combine a plurality of the first cryptographic algorithms, wherein the operators specify how to combine the cryptographic data output by the individual first cryptographic algorithms to obtain the composite cryptographic data. Additionally or alternatively, the second control algorithm contains Boolean operators and/or arithmetic operators that combine a plurality of the second cryptographic algorithms such that their combined application to the transmitted composite cryptographic data and/or to an output of a previously executed second cryptographic algorithm results in data processing that is functionally complementary to the execution of the first cryptographic algorithms.

For example, the first (or second) cryptographic algorithms may implement provider-side (or receiver-side) steps of different cryptographic key agreement keys. The first (or second) control algorithm may contain instructions and arithmetic operators that specify how the keys generated by each of the first (or second) cryptographic algorithms may be combined into a “final key”. For example, the combination may be performed bit by bit by XOR combination. It is also possible for one bit of a particular key (or a plurality of the keys) to be interleaved with a factor (for example “3” or any other number) according to an arithmetic operator (for example by multiplication or addition). Thus, a plurality of first and second control algorithms may be defined that must functionally correspond to each other and may be used, for example, in applications where knowledge of a particular control algorithm (and its exact operators and factors) is used to prove identity or authorisation. According to embodiments of the invention, the first and/or second control algorithm have an identifier. According to preferred embodiments of the invention, the first control algorithm and a functionally complementary second control algorithm have a common identifier.

According to embodiments of the invention, this identifier (and the corresponding functionality of the control algorithms) is formed as one of the following identifiers (wherein the provider cryptosystem and/or the receiver cryptosystem may include a plurality of control algorithms supporting different ones of the identifiers and functions mentioned below):

“SIGNATURE AND”:

The SIGNATURE AND identifier identifies a first control algorithm of the provider cryptosystem. This first control algorithm specifies to compute a signature by means of one or more first cryptographic algorithms each implementing a signature algorithm.

The SIGNATURE AND identifier identifies a second control algorithm of the receiver cryptosystem specifying to verify, by means of one or more second cryptographic algorithms each implementing a signature verification algorithm, a signature created by means of a signature algorithm corresponding (i.e. functionally complementary) to that signature verification algorithm. The second control algorithm specifies that the results data are computed in such a way that they confirm the integrity and/or authenticity of the composite cryptographic data precisely when all signature checks performed by the signature verification algorithms show that the checked signature is valid.

“SIGNATURE OR”:

The SIGNATURE OR identifier identifies a first control algorithm of the provider cryptosystem. This first control algorithm specifies to compute a signature by means of one or more first cryptographic algorithms each implementing a signature algorithm.

The SIGNATURE OR identifier identifies a second control algorithm of the receiver cryptosystem. The second control algorithm specifies to verify, by means of one or more second cryptographic algorithms each implementing a signature verification algorithm, a signature created by means of a signing algorithm corresponding to the signature verification algorithm, at least until at least one of the signature verification algorithms concludes that the signature is valid or until all signature verification algorithms of the receiver cryptosystem have been performed. The results data will be computed in such a way that they confirm the integrity and/or authenticity of the composite cryptographic data precisely when at least one of the signature verification algorithms concludes that the checked signature is valid.

“SIGNATURE K-of-N”:

The SIGNATURE K-of-N identifier identifies a first control algorithm of the provider cryptosystem. This first control algorithm specifies to compute a signature by means of one or more first cryptographic algorithms each implementing a signature algorithm.

The SIGNATURE K-of-N identifier identifies a second control algorithm of the receiver cryptosystem. The second control algorithm specifies to verify, by means of K second cryptographic algorithms each implementing a signature verification algorithm, a signature created by means of a corresponding signing algorithm at least until at least K of the signature verification algorithms conclude that the checked signature is valid or until all of the signature verification algorithms have been performed. The results data are computed in such a way that they confirm the integrity and/or authenticity of the composite cryptographic data precisely when at least K of the signature verification algorithms have concluded that the checked signature is valid, wherein K is a number greater than 0, preferably greater than 1. K and N are each integers greater than 0, wherein N is greater than or equal to K.

The “signature K-of-N” procedure is an example of how the parametric specifications of two functionally complementary first and second control algorithms may be different. For example, the parameter “K” has no function in the provider system. In the receiver system, it specifies the minimum number of second cryptographic algorithms that must be successfully applied to the composite cryptographic data to successfully complete the procedure (for example signature verification, key agreement, decryption, etc.).

“KEY AGREEMENT AGGREGATE”,

The KEY AGREEMENT AGGREGATE identifier identifies a first control algorithm of the provider cryptosystem. This first control algorithm specifies to compute a cryptographic key by means of one or more first cryptographic algorithms each implementing provider-side key agreement steps according to a particular key agreement procedure, and to compute a final key by aggregation of all these keys. For example, the aggregation may comprise the following steps: bringing all the keys to a uniform length, for example by shortening some of the keys to a predefined length and/or padding some of the keys with predefined values to the desired length; aligning (matching) the keys of the predefined length bit by bit; and aggregating the bit information of the aligned keys bit by bit by means of an XOR function or other aggregation function. The result is a final key of the desired length. Instead of the XOR function, any other function that aggregates the bits of a plurality of keys at a particular position in a defined way may be used.

The KEY AGREEMENT AGGREGATE identifier identifies a second control algorithm of the receiver cryptosystem. The second control algorithm specifies to compute a cryptographic key by means of one or more second cryptographic algorithms each implementing receiver-side steps of a key agreement procedure, and to compute a final key by aggregation of all these keys.

DATA-ENCRYPTION-ITERATIVE

The DATA ENCRYPTION ITERATIVE identifier identifies a first control algorithm of the provider cryptosystem. The first control algorithm specifies to compute, by means of one or more first cryptographic algorithms each implementing an encryption algorithm, a ciphertext according to a particular encryption procedure. The encryption algorithms are executed sequentially. The first executed encryption algorithm uses the input data as input and all subsequently executed encryption algorithms each use the ciphertext generated by the previously executed encryption algorithm as input.

The DATA ENCRYPTION ITERATIVE identifier identifies a second control algorithm of the receiver cryptosystem. The second control algorithm specifies, by means of one or more second cryptographic algorithms each implementing a decryption algorithm, to decrypt a ciphertext according to a particular decryption procedure to obtain decrypted data. The decryption algorithms are executed sequentially. The first executed decryption algorithm uses as input the ciphertext provided by the provider computer system and all subsequently executed decryption algorithms each use the decrypted data generated by the previously executed decryption algorithm as input.

In the sequential encryption, it is possible that only the component parameters used by the first-executed decryption algorithm (second cryptographic algorithm) are provided to the receiver cryptosystem. The component parameters of the later-executed second cryptographic algorithms are then only extracted step by step in the course of the sequential decryption, for example when the first control algorithm applies each of the individual encryption algorithms to the output of the previously executed encryption algorithm. Preferably, however, the algorithm designators and component parameters, required by some algorithms, of all second cryptographic algorithms to be executed are immediately apparent from the parameters provided by the provider cryptosystem alongside the composite cryptographic data, so that the receiver cryptosystem may determine whether it supports all second cryptographic algorithms specified in the parameters for the second control algorithm by means of the algorithm designators even before execution of all second cryptographic algorithms begins.

DATA ENCRYPTION PARALLEL:

The DATA ENCRYPTION PARALLEL identifier identifies a first control algorithm of the provider cryptosystem. The first control algorithm specifies to compute a ciphertext by means of one or more first cryptographic algorithms each implementing an encryption algorithm, wherein each of the encryption algorithms uses the input data or parts thereof as input.

The DATA ENCRYPTION PARALLEL identifier identifies a second control algorithm of the receiver cryptosystem. The second control algorithm specifies, by means of a plurality of second cryptographic algorithms each implementing a decryption algorithm, decrypting a ciphertext according to a particular decryption method to obtain decrypted data, wherein each of the decryption algorithms uses as input the ciphertext provided by the provider computer system.

The parallel encryption of data by means of a plurality of encryption procedures may be useful, especially in the context of encrypted data archives, to ensure that even years and decades later at least one decryption method then still in use may be used to decrypt at least the partial data of the composite cryptographic data set corresponding to this decryption procedure.

“KEY CONTAINER”:

The KEY CONTAINER identifier identifies a first control algorithm of the provider cryptosystem. This first control algorithm specifies how an individual composite key is formed using one or more first cryptographic algorithms each describing a key.

This composite key may, for example, be a concatenate of individual keys, each of which is formed by one of the first cryptographic algorithms. The individual cryptographic keys may have different functions, for example may serve as encryption keys or signing keys or decryption keys or signature verification keys. The execution of a “KEY CONTAINER” control algorithm may thus be used to form a key concatenate that serves as a container for a plurality of cryptographic keys of the same or different function. Thus, by providing composite cryptographic data in the form of a “key container” in a single data exchange step, a large number of keys may be provided to the receiver cryptosystem for a wide variety of purposes, so that the number of data exchange steps and, associated with this, the amount of data that may have to be transmitted over the network is reduced.

The KEY CONTAINER identifier further identifies a second control algorithm of the receiver cryptosystem specifying how, by means of one or more second cryptographic algorithms, one or more cryptographic keys may be extracted and/or used from the composite cryptographic data. The second cryptographic algorithms used by the second control algorithm each specify a method for extracting, reconstructing and/or using a cryptographic key from those parts of the composite cryptographic data which were created by means of a first cryptographic algorithm corresponding to this second cryptographic algorithm. The results data here therefore consist of the cryptographic keys extracted and/or reconstructed from the container or the composite cryptographic data.

According to embodiments, the composite cryptographic data contain algorithm designators and optionally component parameters of at least some of the second cryptographic algorithms to be used to process the composite cryptographic data. The algorithm designators and component parameters may be part of the composite cryptographic data, for example in some embodiments, in the case of iterative encryption, the algorithm designators and component parameters provided by the previously executed encryption algorithm may also be encrypted to form a ciphertext. Preferably, the algorithm designators and optional component parameters are provided separately but together with the composite cryptographic data (and optional control parameters for the second control algorithm). This has the advantage that the receiver cryptosystem may very quickly determine, by analysing the separately provided algorithm designators, whether it is able to perform the second control function at all with the second cryptographic algorithms identified by the algorithm designators, or whether individual second cryptographic algorithms are not supported at all, for example.

The composite cryptographic data may be provided for example in the same data structure together with said parameters (algorithm designator of the second cryptographic algorithms to be used by the second control algorithm and optionally component parameters of these second cryptographic algorithms and control parameters), wherein the composite cryptographic data and the parameters are stored for example in different fields. The algorithm designator of the individual second cryptographic algorithms may be, for example, an identifier of the cryptographic method implemented by the first cryptographic algorithm, such as “RSA” or “DH” or the algorithm designators used according to established standards.

Embodiments may have the advantage that, on the one hand, the provider cryptosystem may ensure a minimum level of security on the receiver side during data processing by having the selection of the second cryptographic algorithms determined by the first control function and stored in the data structure. However, precise knowledge of the cryptographic algorithms supported by the receiver cryptosystem is not necessary, since a second control algorithm that provides an OR or K-of-N operation may also work if only a single or an arbitrarily composed selection K of the second cryptographic algorithms specified in the data structure provided are supported by the receiver system.

For example, the quantum security of RSA signatures is considered compromised, whereas alternative signature algorithms such as BLISS, Tesla or Dilithium are currently considered quantum-secure. The receiver cryptosystem could perform an initial control function, which is a SIGNATURE OR control function and which applies three different signing procedures to input data to obtain the composite cryptographic signature, namely RSA, Tesla and Dilithium. The data structure provided contains the “SIGNATURE OR” identifier of the second control algorithm and the corresponding algorithm designators Tesla, Dilithium and RSA of the second signature verification procedures to be combined. Thus, older, non-quantum-secure receiver cryptosystems may also verify the composite signature, provided they support RSA. Receiver systems that have already completely switched to quantum-secure procedures, such as Tesla or Dilithium, may also verify the composite signature.

If the operator of the provider cryptosystem believes that RSA has generally become too insecure, they may modify the first control algorithm so that only Tesla and Dilithium are used to generate the composite signature. As a result, a purely RSA-based receiver system is no longer able to verify this signature.

The method further comprises, according to embodiments of the invention, identification by the receiver cryptosystem of each of the second cryptographic algorithms used to compute the results data, within a plurality of second cryptographic algorithms, prior to or during computation of the results data, using the algorithm designators provided together with the composite cryptographic data. Each of the identified second cryptographic algorithms implements receiver-system-side steps of the same cryptographic procedure as a corresponding (functionally complementary) first cryptographic algorithm.

Thus, for example, if one of the first cryptographic procedures is an RSA algorithm, an identifying designator of the RSA algorithm is provided as the algorithm designator of this first cryptographic algorithm by the provider cryptosystem together with the composite cryptographic data. The RSA algorithm designator thus also automatically specifies that the second cryptographic algorithm corresponding to it is RSA.

According to other embodiments, in addition to the composite cryptographic data, only the identifier of the second control algorithm and optionally its control parameters are provided by the provider cryptosystem, but not algorithm designators and control parameters of the individual second cryptographic algorithms. In this case, the identifier of the second control algorithm only determines the type of combination of the individual second algorithms (for example AND or OR variant, SEQUENTIAL or PARALLEL variant, K-of-N variant, etc.), not the selection of the second algorithms. For example, the receiver cryptosystem may thus be configured to use all second cryptographic algorithms supported by the receiver system and to combine them according to the second control algorithm.

According to embodiments, the second control algorithm is provided as a template that is completed by the receiver cryptosystem in response to the receipt of the composite cryptographic data and the associated parameters (algorithm designators of the second cryptographic algorithms and optionally also their component parameters and optional control parameters). For example, in such a receiver-side template, for example for the SIGNATURE AND control algorithm, it is specified that one or more signature verification algorithms (but not for example encryption/decryption algorithms) are to be performed, which are logically connected by AND operator. The algorithm designators of the second cryptographic algorithms are not contained in the template in this embodiment. Thus, for example, if one of the first cryptographic procedures used by the first control algorithm is an RSA algorithm, an algorithm designator of the RSA algorithm is transmitted from the provider cryptosystem to the receiver cryptosystem together with the composite cryptographic data. The RSA algorithm designator is transferred into the template as an input parameter for the second control algorithm specified in the template, completing the template and thus also the second control algorithm. Thus, the provider cryptosystem and the receiver cryptosystem do not have to agree in advance that the steps of the RSA procedure on the provider side or on the receiver-system-side have to be carried out when executing the first or functionally complementary second control algorithm. Rather, this information is determined dynamically and individually for the specifically transmitted composite cryptographic data by the parameters transmitted together with them and may thus be determined dynamically and very flexibly for each of the second cryptographic algorithms to be used by the receiver system, depending on the provider cryptosystem, application scenario or configuration of the provider cryptosystem.

According to embodiments, the provider cryptosystem is configured to allow a user, via a GUI, to specify the first cryptographic algorithms used by each of the one or more of the first control algorithms, wherein the specification is preferably reversible so that it may be changed at any time during operation of the provider cryptosystem.

According to embodiments of the invention, the method comprises receiving configuration data from a user or an application program by the provider cryptosystem, for example via the GUI, wherein the configuration data specify a plurality of first cryptographic algorithms and include, for example, algorithm designators and optionally also component parameters. In the next step, the first control function is generated or modified such that the first cryptographic algorithms used by the first control algorithm are those identified in the configuration data. The executed first cryptographic algorithms establish the identity of the second cryptographic algorithms selected and/or combined by the second control algorithm (for example by means of algorithm designators, contained in the transferred parameters, which may be supplemented by the optional component parameters).

Correspondingly, the receiver cryptosystem is configured to select the second control algorithm on the basis of an identifier provided together with the composite cryptographic data and the second cryptographic algorithms used by the second control algorithm on the basis of the algorithm designators also provided.

This may have the advantage that it may be determined on the side of the provider cryptosystem which second control algorithm must be executed with which second cryptographic algorithms in order to process the composite cryptographic data. Thus, the provider cryptosystem may define the security level of the receiver-side processing.

According to embodiments of the invention, providing the composite cryptographic data comprises storing the composite cryptographic data in an individual first predefined field of a data structure agreed between the provider cryptosystem and the receiver cryptosystem. The receiver cryptosystem is configured to read and parse the first predefined field of the data structure to obtain the composite cryptographic data.

For example, this data structure may be transmitted directly to the receiver cryptosystem, for example via a network. Additionally or alternatively, the data structure may also be stored in a volatile or non-volatile data memory, for example in a database used as an archive, wherein the receiver system currently has, or will have at a future time of access, read rights with respect to this data memory.

For example, the provider cryptosystem may generate a plurality of different signatures by means of a plurality of signature generation procedures, the signatures being stored (for example in concatenated form) as composite cryptographic data in the first predefined field. Alternatively, the composite cryptographic data may also contain a plurality of ciphertexts generated in parallel, or a sequentially generated ciphertext, or an agreed final key, or a key container, etc. The fact that the composite cryptographic data are always written to a single field of the data structure, regardless of the number of first cryptographic algorithms used to generate said data, may have the advantage that no adjustments need to be made in the program code to the data structure, either on the provider side or the receiver side, depending on the number or type of first or second cryptographic algorithms involved. This “structure conservativity” in combination with the possibility of combining a plurality of first or second cryptographic algorithms in different sequence and/or different composition and/or in different combination modes (parallel or sequential) and/or with different stringency of data processing (AND or OR or K-of-N-linked), offers, according to embodiments, a maximum of flexibility, configurability and expandability with simultaneously very high constancy with regard to the data structure that is exchanged and agreed between the participants.

According to embodiments of the invention, the provider cryptosystem stores an identifier of the second control algorithm to be executed by the receiver cryptosystem to select and coordinate the combination of those second cryptographic algorithms to be used for processing the provided composite cryptographic data. The identifier may be, for example, one of the above-mentioned identifiers, for example SIGNATURE OR, SIGNATURE AND, etc. The identifier of the second control algorithm is stored in a second predefined field of the data structure.

The receiver cryptosystem reads and parses the identifier from the second predefined field of the data structure and selects the second control algorithm on the basis of the read identifier.

According to preferred embodiments, the algorithm designators of the second control algorithms to be terminated by the second control algorithm, as well as optionally the component parameters required by these, as well as optionally control parameters required by the second control algorithm, are also stored in the data structure. Preferably, these data are stored as parameters of the second control algorithm.

Preferably, the second field of the data structure has a structure predefined in a standard with a predetermined first input area for an individual (conventional) cryptographic algorithm designator and a predetermined second input area for the parameters of this (conventional) cryptographic algorithm, wherein the identifier of the second control algorithm is stored in the first input area and said parameters of the second control algorithm are stored in the second input area.

According to embodiments, the agreed data structure is a certificate, in particular an X.509 certificate.

According to embodiments, the first predefined field is a field defined in a standard, in particular a conventional standard for cryptographic algorithms and/or data structures, for specifying a single cryptographic algorithm. Examples of such standards are:
Recommendation ITU-T X.509
ISO/IEC 9594-8: Information technology—Open Systems Interconnection—The Directory: Public-key and attribute certificate frameworks
RFC 5280: Internet X.509 Public Key Infrastructure Certificate and Certificate Revocation List (CRL) Profile, May 2008
BSI TR 03110 Advanced Security Mechanisms for Machine Readable Travel Documents and eIDAS token
RFC 5652: Cryptographic Message Syntax (CMS), August 2009
RFC 2986: PKCS #10: Certification Request Syntax Specification, Version 1.7, November 2000
RFC 6990: X.509 Internet Public Key Infrastructure—Online Certificate Status Protocol—OCSP, June 2013
ICAO Doc 9303, Machine Readable Travel Documents, Seventh Edition, 2015, Part 11: Security Mechanisms for MRTDs
ICAO Doc 9303, Machine Readable Travel Documents, Seventh Edition, 2015, Part 12: Public Key Infrastructure for MRTDs
Various other standards for other formats (XML, PDF)

According to embodiments of the invention, the plurality of first cryptographic algorithms comprise a plurality of cryptographic signature algorithms according to a plurality of different signing procedures. The second cryptographic algorithms comprise a plurality of cryptographic signature verification algorithms each implemented according to one of the different signing procedures.

According to embodiments of the invention, computing the composite cryptographic data comprises:
applying each of the plurality of cryptographic signature algorithms to the input data to compute a signature; the signature may comprise, for example, parameters (in particular algorithm designators and optionally used component parameters of the applied signature algorithm) which identify the signing procedure used by the particular cryptographic signature algorithm and which implicitly also identify a suitable signature verification algorithm;
combining the plurality of signatures to form the composite cryptographic data; the parameters created may be part of the composite cryptographic data or, preferably, provided separately and in conjunction with the composite cryptographic data;
storing the composite cryptographic data in a first predefined field of a data structure agreed between the provider cryptosystem and the receiver cryptosystem.

Preferably, the parameters (algorithm designator and optionally used component parameters of the applied signature algorithms as well as optionally control parameters) are stored in a second predefined field of the data structure.

The transmission of at least the composite cryptographic data from the provider cryptosystem to the receiver cryptosystem is performed in the course of a transmission of the input data and the data structure to the receiver cryptosystem.

According to one embodiment, each signature generated by one of the first cryptographic algorithms comprises a pair formed of algorithm designator and the value of the signature. Optionally, the algorithm designator may be provided in conjunction with parameters that the designated algorithm requires as input to be able to verify the signature.

Preferably, the signatures of the individual signature algorithms are stored as a composite signature in the first field. The algorithm designators and component parameters of the signature algorithms and, optionally, control parameters of the second control algorithm are stored in the second field as parameters for the second control algorithm together with the identifier of the second control algorithm. Thus, the parameters may comprise a plurality of component parameters and algorithm designators “composed” from the component parameters of the first cryptographic algorithms and may be considered as “composite parameters” stored separately from the composite cryptographic data.

Thus, in structural terms, the composite cryptographic data on the one hand and the combination of identifier of the second control algorithm with the “composite” parameters on the other hand form a tuple of cryptographic data, (control) algorithm designator and parameters that may be stored in the corresponding fields and input areas of standard-compliant cryptographic data structures, without having to break or change the data structure, although the composite cryptographic data and parameters have a significantly higher information content and may be used more flexibly than the corresponding data and parameters of individual cryptographic algorithms for which these data structures were originally designed.

The composite cryptographic data may thus be provided as a pair in a similar way to cryptographic data from individually used cryptographic algorithms, namely for example as a combination of the (composite) cryptographic data on the one hand and an algorithm designator (of the second control algorithm) and its parameters on the other hand.

According to embodiments of the invention, the computation of the results data by the receiver cryptosystem comprises:
parsing, by the receiver cryptosystem, of the fields of the data structure agreed between the provider cryptosystem and the receiver cryptosystem to obtain the composite cryptographic data stored in a first field, and to extract the identifier of the second control algorithm stored in a second field of the data structure and further parameters, wherein the parameters comprise algorithm designators of signature verification algorithms suitable for signature verification, and optionally also component parameters of these signature verification algorithms and/or control parameters of the second control algorithm;
computing signature verification partial results by the receiver cryptosystem by applying each of the identified signature verification algorithms to those of the signatures computed with a signing procedure corresponding to the signature verification algorithm;
generating the results data by combining the signature verification partial results according to the second control algorithm.

For example, the results data may include a result as to whether the provider cryptosystem or a message of the provider cryptosystem is to be treated as integer and/or as originating from a particular provider entity.

According to embodiments, the second control algorithm is determined by the first control algorithm and an identifier of the determined second control algorithm is stored in the data structure together with the composite cryptographic data. For example, a particular cryptographic program or program module for particular applications or functions may execute a particular first control algorithm that specifies, for example, that a particular number of (for example, three) signature algorithms each generate a digital signature for an electronic document and writes those three signatures as the composite cryptographic data into the first field of the data structure. In addition, the first control algorithm may be configured to write into the second field of the data structure a “SIGNATURE AND” identifier and the algorithm designators of the signature algorithms used, together with optional component parameters and optional control parameters for the SIGNATURE AND control algorithm. The receiver cryptosystem is configured to select and execute the second control algorithm depending on the identifier specified in the second field.

According to embodiments of the invention, the plurality of first cryptographic algorithms comprise a plurality of cryptographic encryption algorithms according to a plurality of different encryption procedures. The plurality of second cryptographic algorithms comprise a plurality of cryptographic decryption algorithms corresponding to the plurality of different encryption procedures.

According to embodiments of the invention, computing the composite cryptographic data comprises:
applying each of the plurality of cryptographic encryption algorithms to the input data and/or the output of a previously executed one of the cryptographic encryption algorithms to generate encrypted data used as the composite cryptographic data, wherein the encrypted data output by each of the encryption algorithms may optionally comprise parameters; said parameters may comprise algorithm designators of the encryption procedures used by the particular cryptographic encryption algorithm and optionally also component parameters of said encryption procedures and/or control parameters for the second control algorithm; preferably, however, said parameters are not incorporated as input into the subsequent encryption algorithms but are output separately in the form of composite parameters together with the composite cryptographic data; and
storing the composite cryptographic data in a first predefined field of a data structure agreed between the provider cryptosystem and the receiver cryptosystem. The transmission of at least the composite cryptographic data from the provider cryptosystem to the receiver cryptosystem is performed in the course of a transmission of the data structure to the receiver cryptosystem.

According to embodiments of the invention, the plurality of cryptographic encryption algorithms are applied sequentially in each case to the input data or to the output of the most recently performed encryption algorithm. The output of the most recently applied cryptographic encryption algorithm is used to constitute the composite cryptographic data. For example, the composite cryptographic data may be sequentially encrypted data that are transformed back to the input data by sequentially applying each of the second cryptographic algorithms to the output of the previously executed second algorithm.

According to other embodiments, the application of the plurality of cryptographic encryption algorithms is such that each of the plurality of encryption algorithms is applied to the input data to produce an encrypted output value, and wherein the computation of the composite cryptographic data comprises a concatenation or other form of combination of the encrypted output values to form the combined cryptographic data.

For example, the concatenation may be performed in such a way that a delimiter, which is also known to the second control algorithm, separates the partial data generated by the individual first cryptographic algorithms. The second control algorithm may use the delimiter to split the composite cryptographic data into partial data and assign them to the individual second cryptographic algorithms for further processing. Preferably, the concatenation is not based on a delimiter, but on a TLV (Tag-Length-Value), i.e. a fixed character sequence length, which may be specified for example in ASN.1-Distinguished Encoding Rules (DER) encoding, or by means of XML, so that the receiver system may determine the parts of the composite cryptographic data provided by different first cryptographic algorithms on the basis of the fixed character sequence length. All embodiments described here that use a delimiter to form the composite cryptographic data may alternatively also apply any other method to allow the receiver system to identify the cryptographic data provided by the individual first cryptographic algorithms, for example a TLV.

According to embodiments, the computation of the results data by the receiver cryptosystem comprises:
parsing, by the receiver cryptosystem, of the fields of the data structure agreed between the provider cryptosystem and the receiver cryptosystem to obtain the composite cryptographic data contained in a first field, and to extract the identifier of the second control algorithm stored in a second field of the data structure and further parameters, wherein the parameters comprise algorithm designators of decryption algorithms suitable for decrypting the ciphertext contained in the composite cryptographic data, wherein the parameters optionally also comprise component parameters of these decryption algorithms and/or control parameters of the second control algorithm;
generating decrypted data by the receiver cryptosystem by applying each of the identified decryption algorithms to those of the decrypted data generated by an encryption procedure corresponding to the encryption algorithm;
generating the results data by combining the decrypted data or by combined application of the identified decryption algorithms according to the second control algorithm, wherein the results data include at least a part of the input data in unencrypted form. This step may also be performed together with the previous step of generating the decrypted data, for example when the second cryptographic algorithms are applied in series.

According to embodiments of the invention, the plurality of cryptographic decryption algorithms are applied sequentially to the output of the most recently performed decryption algorithm. The output of the most recently applied cryptographic decryption algorithm is used to constitute the results data.

Alternatively, the application of the plurality of cryptographic decryption algorithms is such that each of the plurality of decryption algorithms is applied to the encrypted data contained in the field to produce decrypted data, wherein the decrypted data of one of the decryption algorithms are used as the results data.

According to embodiments of the invention, the plurality of first cryptographic algorithms comprise a plurality of provider-side key agreement algorithms according to a plurality of different key agreement procedures. The second cryptographic algorithms comprise a plurality of receiver-side key agreement algorithms, each implemented corresponding to one of the different key agreement procedures.

According to embodiments of the invention, computing the composite cryptographic data comprises:
applying each of the plurality of provider-side key agreement algorithms to the input data to generate key data, wherein the key data are or comprise cryptographic keys and/or seeds (data values, for example random numbers, used as the basis of a computation) or parameters for generating cryptographic keys, wherein the key data comprise algorithm designators and optionally associated component parameters identifying the key agreement procedure used by the particular provider-side key agreement algorithm;
combining the plurality of key data to form the composite cryptographic data; the parameters of the individual key agreement algorithms may be provided in the composite cryptographic data or, preferably, separately associated therewith;
storing the composite cryptographic data in a first predefined field of a data structure agreed between the provider cryptosystem and the receiver cryptosystem.

Preferably, the algorithm designator and optionally associated component parameters of the individual first cryptographic algorithm, the identifier of the second control algorithm and optional control parameters are stored in a second data field of the data structure.

The transmission of at least the composite cryptographic data from the provider cryptosystem to the receiver cryptosystem is performed in the course of a transmission of the input data and the data structure to the receiver cryptosystem.

According to embodiments of the invention, the computation of the results data by the receiver cryptosystem comprises:
parsing, by the receiver cryptosystem, of the fields of the data structure agreed between the provider cryptosystem and the receiver cryptosystem to obtain the composite cryptographic data contained in a first field, and to extract the identifier of the second control algorithm stored in a second field of the data structure and further parameters, wherein the parameters comprise algorithm designators of receiver-side key agreement algorithms functionally complementary to those used to generate said provider-side key data comprised in the composite cryptographic data, wherein the parameters optionally include component parameters of the receiver-side key agreement algorithms and/or control parameters;
generating receiver-side key data by the receiver cryptosystem by applying each of the identified receiver-side key agreement algorithms as a function of those key data generated on the provider side by a provider-side key agreement algorithm corresponding to the receiver-side key agreement algorithm;
generating the results data by combining the key data generated on the receiver side according to the second control algorithm, wherein the results data include at least one key agreed between the provider cryptosystem and the receiver cryptosystem.

According to embodiments of the invention, the input data include a text, at least one parameter of a cryptographic procedure, and/or at least one cryptographic key.

In a further aspect, the invention relates to a provider cryptosystem. The provider cryptosystem comprises a volatile or non-volatile storage medium comprising a plurality of first cryptographic algorithms and comprising at least one first control algorithm, wherein a first control algorithm is a computational rule for selecting and/or combining two or more of the first cryptographic algorithms. The provider cryptosystem further comprises at least one processor configured to:
generate input data;
compute composite cryptographic data by executing a plurality of the first cryptographic algorithms, wherein the composite cryptographic data are computed as a function of the input data, wherein the plurality of first cryptographic algorithms and/or a combination of the plurality of first cryptographic algorithms are selected according to the at least one first control algorithm;
providing the composite cryptographic data from the provider cryptosystem to the receiver cryptosystem. For example, the composite cryptographic data may be stored in a data structure, for example a certificate, in a predefined first field. The data structure may be part of a message that contains other data. For example, the message may comprise an electronic document and may contain a certificate, the first field of which contains a signature composed of a plurality of individual signatures instead of a conventional signature, wherein the second control algorithm to be used by the receiver cryptosystem to process the data contained in the first field is specified by means of an identifier in a second field of the data structure. However, the message may also consist only of the data structure. Thus, depending on the embodiment, the provider cryptosystem may provide only the data structure or a larger data set or a message that contains other data in addition to the data structure, for example a signed electronic document.

According to embodiments, the provider cryptosystem is configured to perform the provider-system-side steps of the method.

According to embodiments, the provider cryptosystem comprises:
a first cryptographic application including the first cryptographic algorithms and the first control algorithms, and
a first application program.

The first application program is free of cryptographic algorithms and may implement any application, for example a mail program, a program for generating and providing medical data, etc. The first application program is interoperable with the first cryptographic application and is configured to perform the following steps:
provide the input data to the first cryptographic application and/or cause the first cryptographic application to generate the input data;
cause the first cryptographic application to compute and return the composite cryptographic data to the first application program;
store the composite cryptographic data in a first predefined field of a data structure agreed between the provider cryptosystem and the receiver cryptosystem; and
send the data structure to the receiver cryptosystem.

The separation of application logic and cryptography-related functions into different programs and/or modules described here may have the advantage that the application program remains unchanged, even if an old cryptographic application that has always returned very specific cryptographic data for a very specific algorithm is replaced by a new cryptographic application that now returns composite cryptographic data. The application program continues to store the composite cryptographic data in the same predefined field that is already used, for example, according to standards used today to store cryptographic data such as signatures or cryptographic keys. Thus, nothing changes for the application program if the previously used cryptographic module, which wrote individual cryptographic values into individual designated fields according to the existing standards, is replaced by a new cryptographic program or module, which now writes composite cryptographic data into this one field. By using provider cryptosystems with correspondingly modular separation of application logic and cryptographic functions, it may be ensured that a changeover of the provider cryptosystem to new, quantum-computer-secure cryptographic algorithms may be made without having to rewrite and/or recompile application programs for this purpose.

In a further aspect, the invention relates to a receiver cryptosystem. The receiver cryptosystem comprises a volatile or non-volatile storage medium having one or more second cryptographic algorithms and at least one second control algorithm.

The second control algorithm is a computational rule for selecting and/or combining one or more of the second cryptographic algorithms. The receiver cryptosystem further comprises at least one processor configured to:
receive composite cryptographic data from the provider cryptosystem;
compute results data as a function of the composite cryptographic data by applying one or more of the second cryptographic algorithms, wherein the one or more second cryptographic algorithms are selected and/or combined according to one of the second control algorithms; and
automatically execute a software and/or hardware function depending on the results data.

According to embodiments, the receiver cryptosystem is configured to perform the receiver-system-side steps of the method.

According to embodiments, the receiver cryptosystem comprises:
a second cryptographic application containing the second cryptographic algorithms and the second control algorithms; and
a second application program which is free of cryptographic algorithms and which is interoperable with the second cryptographic application.

The second application program is configured to:
receive a data structure agreed between the provider cryptosystem and the receiver cryptosystem;
parse the data structure to read the composite cryptographic data from a first predefined field in the data structure;
provide the read composite cryptographic data to the second cryptographic application;
cause the second cryptographic application to compute and return to the second application program the results data as a function of the composite cryptographic data; and
cause the automatic execution of the software and/or hardware function depending on the results data.

For example, the first and/or second application program may be configured to process S/MIME messages and associated certificates or signatures, wherein the actual cryptographic operations are outsourced to the cryptographic application interoperable with this application program. S/MIME stands for Secure/Multipurpose Internet Mail Extensions and refers to a standard for the encryption and signing of MIME objects using a hybrid cryptosystem. S/MIME is used in many cryptographic procedures to secure the application layer. Typical applications of S/MIME are e-mail, AS2 and many others. In practice, S/MIME (content layer) may be combined with TLS (transport layer). For example, the first or second cryptographic application may perform the cryptographic operations during S/MIME processing on the transport layer.

In a further aspect, the invention relates to a data structure.

The data structure has a format agreed between a provider cryptosystem and a receiver cryptosystem according to a cryptographic standard. The cryptographic standard may in particular be a conventional cryptographic procedure standard and/or data structure standard. The data structure includes a first predefined field which, according to the cryptographic standard, is used to store cryptographic data of exactly one cryptographic algorithm. The first predefined field contains (contrary to this conventional cryptographic standard) composite cryptographic data. The composite cryptographic data are composed of cryptographic partial data, each generated by a plurality of cryptographic algorithms. The plurality of cryptographic algorithms may be, for example, a plurality of first cryptographic algorithms implemented on a provider cryptosystem.

Preferably, the data structure includes a second predefined field which, according to the cryptographic standard, is used to store an algorithm designator of exactly one cryptographic algorithm. The second predefined field contains an identifier of the second control algorithm as well as algorithm designators of the second cryptographic algorithms to be used by it and optionally component parameters and/or control parameters of the second control algorithm.

Such a data structure may have the advantage that its processing at the application level (for example by an S/MIME program) may be largely identical to the processing of corresponding data structures in which the first field contains the content according to the conventional cryptographic standard. In the first field, where, according to the conventional cryptographic standard, the signature or ciphertext generated by an individual cryptographic algorithm or the agreed key should be contained, there are according to embodiments the composite cryptographic data generated by a plurality of cryptographic algorithms. These may be read out by the application program in the same way as before and forwarded to the cryptographic application for processing. Only the cryptographic application may need to be adapted, as it must be configured to write composite cryptographic data into the first field or to read and process same from the first field instead of the results of an individual cryptographic algorithm.

According to embodiments, the data structure includes an identifier of the format, for example an identifier of the cryptographic standard or an identifier of a data structure type. For example, an X.509 certificate includes a field indicating the version of the X.509 certificate. The standard value is version 1. If the issuer's unique designator or the subject's unique designator exists, the value must be version 2. The majority of applications used today use V3.

According to embodiments of the invention, the data structure is a certificate. The certificate may be, for example, an X.509 certificate. The X.509 certificate may, for example, be a TLS certificate. According to further examples, the certificate may be a CV certificate (Card Verifiable Certificate).

According to embodiments of the invention, the data structure is an X.509 from version V1 or higher, associated with an entity. The entity may be, for example, a natural or legal person or a technical device or object.

According to embodiments, the cryptographic data of the exactly one cryptographic algorithm (to be stored in the first field according to the conventional cryptographic standard) are constituted by a ciphertext, a cryptographic key or a digital signature.

According to embodiments, the cryptographic partial data is a ciphertext, a cryptographic key or a digital signature. The first field is a field designated according to a cryptographic standard for storing the cryptographic data generated by an individual cryptographic algorithm. In addition or alternatively, the second field is a field designated according to a cryptographic standard for storing an algorithm designator of an individual cryptographic algorithm including optionally present parameter values.

According to embodiments of the invention, each of the partial data include parameters, wherein the parameters identify an algorithm designator identifying the second cryptographic algorithm with which the partial data are to be processed, and optionally also component parameters controlling the processing. For example, the composite cryptographic data may include pairs of the outputs generated by each of the individual first cryptographic algorithms and the algorithm designator and optionally also component parameters of the particular second cryptographic algorithm.

However, according to preferred embodiments, the algorithm designators of the second cryptographic algorithms, component parameters optionally assigned to them, and optionally present control parameters are stored and provided together as “composite parameters” separately but linked to the composite cryptographic data and an identifier of the second control algorithm.

According to embodiments, the receiver cryptosystem is configured to determine, on the basis of an analysis of data together with the composed cryptographic data also containing algorithm designators, before the second control algorithm is executed, whether the second cryptographic algorithms identified in the second control algorithm are supported by the receiver cryptosystem. If not, the second control algorithm is not executed, which saves resources.

According to some embodiments, the algorithm designators and/or component parameters of the second cryptographic algorithms also implicitly specify the bit length and/or first position of the cryptographic data. These data may allow the receiver cryptosystem to provide identification of the start and/or end of these partial data within the field when parsing the data content of the field by the receiver cryptosystem.

In a further aspect, the invention relates to a provider cryptosystem comprising a plurality of first cryptographic algorithms and at least one first control algorithm configured to generate a data structure according to one of the embodiments described herein.

In a further aspect, the invention relates to a receiver cryptosystem comprising a plurality of second cryptographic algorithms and at least one second control algorithm configured to process a data structure according to one of the embodiments described here.

In a further aspect, the invention relates to a provider cryptosystem. The provider cryptosystem comprises at least one processor and a volatile or non-volatile storage medium comprising a plurality of first cryptographic algorithms and at least one first control algorithm. A first control algorithm is a computational rule for selecting and/or combining one or more of the first cryptographic algorithms. The at least one processor is configured to:
generate input data;
compute composite cryptographic data by executing a plurality of the first cryptographic algorithms, wherein the composite cryptographic data are computed as a function of the input data, wherein the plurality of first cryptographic algorithms and/or a combination of the plurality of first cryptographic algorithms are selected according to a first control algorithm;
generate a data structure according to one of the embodiments described here, wherein the data structure has a format agreed between the provider cryptosystem and a receiver cryptosystem, wherein the first predefined field is filled with the composite cryptographic data; and
provide the data structure from the provider cryptosystem to the receiver cryptosystem.

The format of a data structure is understood here to mean, in particular, a specification of the type and/or position and/or content of various fields of a data structure.

In a further aspect, the invention relates to a receiver cryptosystem. The receiver cryptosystem comprises at least one processor and a volatile or non-volatile storage medium having a plurality of second cryptographic algorithms and at least one second control algorithm. A second control algorithm is a computational rule for selecting and/or combining one or more of the second cryptographic algorithms. The at least one processor is configured to:
receive a data structure according to one of the embodiments described here from the provider cryptosystem, wherein the data structure has stored composite cryptographic data in the predefined first field;
compute results data as a function of the composite cryptographic data by applying one or more of the second cryptographic algorithms, wherein the one or more second cryptographic algorithms are selected and/or combined according to a second control algorithm; and
automatically execute a software and/or hardware function depending on the results data.

In a further aspect, the invention relates to a system comprising one or more provider cryptosystems and one or more receiver cryptosystems according to one of the embodiments described herein.

As used herein, a “cryptosystem” or “cryptographic system” means a data processing system that uses cryptographic algorithms. For example, the data processing system may be a standard computer, a notebook computer, a portable telecommunications device, a server, any other data processing system, or combinations of a plurality of these components.

A “cryptographic algorithm” is understood here to mean an algorithm that serves to protect data from unauthorised reading or manipulation and/or to make such manipulation at least detectable. A cryptographic algorithm may be, for example, an encryption algorithm, a decryption algorithm, a signature algorithm, an algorithm for checking a digital signature, or an algorithm for executing user-specific steps of a key agreement procedure.

The term “composite cryptographic data” is understood here to mean data generated by combined application of a plurality of (first) cryptographic algorithms and/or by combination of the data generated by a plurality of first cryptographic algorithms. The composite cryptographic data may, for example, be the result of the application of signature generation algorithms (signature algorithms), encryption algorithms or key agreement algorithms.

A “sequential” execution of algorithms is understood here to be an iterative execution of those algorithms, wherein the first algorithm executed in the sequence is applied to the input data and each of the subsequently executed algorithms is applied to the data returned by the immediately previously executed algorithm.

A “parallel” execution of algorithms is understood here as an execution of a plurality of algorithms, wherein each of these algorithms is applied to the input data or parts thereof and produces an output. The execution of the plurality of algorithms may be carried out in any temporal sequence, for example simultaneously or consecutively in any order.

A “final key” is understood here to be a cryptographic key that is computed as a function of a plurality of other keys (intermediate value keys).

As used herein, “partial data of composite cryptographic data” means data computed by an individual first cryptographic algorithm used by the first control algorithm to compute the composite cryptographic data.

A “field” is defined here as a physical and/or logical area within a data structure that is intended to store data of a predefined meaning and/or function and with predefined properties (for example data type, length, position, etc.) according to an agreement between two or more cryptosystems. A data field may comprise a plurality of input areas, which are also provided for storing, according to the agreement, data of a predefined meaning and/or function and with predefined properties. Storing data other than the intended data in the data field and/or in an input area within the data field typically results in errors or a termination of the data processing. The agreement may be realised, for example, in the form of a cryptographic standard such as X.509 for certificates.

A “parameter” is a data value or set of data values with a specific function or meaning.

A “control parameter” is a parameter that directly controls the way a first or second control algorithm is executed. A control parameter may be transferred as an argument to a control algorithm, for example.

A “component parameter” is a parameter that directly controls the manner of execution of a first or second cryptographic algorithm, and optionally thereby indirectly controls also the execution of a control algorithm that makes use of the first or second cryptographic algorithm. For example, a component parameter may be transferred as an argument to a cryptographic algorithm and/or the control algorithm that makes use of that cryptographic algorithm.

It will be understood to a person skilled in the art that aspects of the present invention may take the form of a device, method or computer program or computer program product. Accordingly, aspects of the present invention may take the form of a hardware-only embodiment, a software-only embodiment (including firmware, in-memory software, micro-code, etc.), or an embodiment combining software and hardware aspects, all of which may be commonly referred to herein as a “circuit”, “module” or “system”. Further, aspects of the present invention may take the form of a computer program product carried by one or more computer readable media in the form of computer-executable code. A computer program also comprises computer-executable code. The term “computer-executable code” may also be referred to as “computer program instructions”.

Any combination of one or more computer readable media may be used. The computer-readable medium may be a computer-readable signal medium or a computer-readable storage medium. A “computer-readable storage medium”, as used herein, comprises a physical storage medium capable of storing instructions executable by a processor of a computer device. The computer-readable storage medium may be referred to as a computer-readable non-volatile storage medium. The computer-readable storage medium may also be referred to as a tangible computer-readable medium. In some embodiments, a computer-readable storage medium may also be capable of storing data that allow it to be accessed by the processor of the computer device. Examples of computer-readable storage media include, but are not limited to: a floppy disk, a magnetic hard disk, a solid-state hard disk, flash memory, a USB flash drive, random access memory (RAM), read-only memory (ROM), an optical disk, a magneto-optical disk, and the processor's register file. Examples of optical disks include Compact Disks (CD) and Digital Versatile Disks (DVD), for example CD-ROM, CD-RW, CD-R, DVD-ROM, DVD-RW or DVD-R disks. The term “computer-readable storage medium” also refers to various types of recording media that are suitable for retrieval by the computer device via a network or communications link. For example, data may be retrieved via a modem, over the Internet, or over a local area network. Computer-executable code executed on a computer-readable medium may be transmitted via any suitable medium, including, but not limited to, wireless, wired, optical fibre, RF, etc., or any suitable combination of the foregoing media.

A computer-readable signal medium may include a propagated data signal containing the computer-readable program code in, for example, a base signal (baseband) or as part of a carrier signal (carrier wave). Such a propagation signal may be configured in any form, including, but not limited to, an electromagnetic form, an optical form, or any suitable combination thereof. A computer-readable signal medium may be any computer-readable medium, other than a computer-readable storage medium, capable of transmitting, distributing or transporting a program for use by or in conjunction with a system, device or apparatus for carrying out instructions.

A “computer memory” or “memory” is an example of a computer-readable storage medium. A computer memory is any memory accessible by a processor. A “computer data memory” or “data memory” is another example of a computer-readable storage medium. A computer data memory is any volatile or non-volatile computer-readable storage medium. In some embodiments, a computer memory may also be a computer data memory, or vice versa.

A “processor” as used herein comprises an electronic component capable of executing a program- or machine-executable instruction or computer-executable code. A reference to the computer device comprising a “processor” should be interpreted as possibly comprising more than one processor or processing cores. For example, the processor may be a multi-core processor. A processor may also refer to a collection of processors within a single computer system or distributed across a plurality of computer systems. The term “computer device” or the computer shall also be interpreted to possibly refer to a collection or network of computer devices or computers each comprising a processor or processors. Computer-executable code may be executed by a plurality of processors, which may be distributed within the same computer device or even across a plurality of computers.

Computer-executable code may comprise machine-executable instructions or a program that causes a processor to perform an aspect of the present invention. Computer-executable code for performing operations for aspects of the present invention may be written in any combination of one or more programming languages, including an object-oriented programming language such as Java, Smalltalk, C++, or the like, and conventional procedure-oriented programming languages such as the “C” programming language or similar programming languages, and translated into machine-executable instructions. In some cases, the computer-executable code may be in the form of a higher-level programming language or in a pre-translated form, and used in conjunction with an interpreter that generates the machine-executable instructions.

The computer-executable code may be executed entirely on a user's computer, partly on the user's computer as a stand-alone software package, partly on the user's computer and partly on a remotely located computer, or entirely on the remotely located computer or server. In the latter case, the remotely located computer may be connected to the user's computer through any type of network, including a local area network (LAN) or wide area network (WAN), or the connection may be made to an external computer (for example, over the Internet using an Internet service provider).

The computer program instructions may be executed on one processor or on a plurality of processors. In the case of a plurality of processors, these may be distributed across a plurality of different entities (for example clients, servers). Each processor could execute a part of the instructions intended for the corresponding entity. Thus, when speaking of a system or method comprising a plurality of entities, the computer program instructions are understood to be adapted to be executed by a processor assigned to or associated with a corresponding entity.

Aspects of the present invention are described with reference to flowchart representations and/or block diagrams of methods, devices (systems) and computer program products according to embodiments of the invention. It is noted that any block or parts of blocks of the flowcharts, representations and/or block diagrams may be executed by computer program instructions, optionally in the form of computer-executable code. It is further noted that combinations of blocks in different flowcharts, representations and/or block diagrams may be combined if they are not mutually exclusive. These computer program instructions may be provided to a processor of a general-purpose computer, special-purpose computer, or other programmable data processing device to generate a device such that the instructions executed via the processor of the computer or other programmable data processing device generate means for executing the functions/steps specified in the block or blocks of flowcharts and/or block diagrams.

These computer program instructions may also be stored on a computer-readable medium capable of controlling a computer or other programmable data processing devices or other devices to operate in a particular manner such that the instructions stored on the computer-readable medium produce a manufactured product, including instructions that implement the function/step specified in the block or blocks of flowcharts and/or block diagrams.

The computer program instructions may also be stored on a computer, other programmable data processing devices or other devices to cause the execution of a series of process steps on the computer, other programmable data processing devices or other devices to produce a process executed on a computer such that the instructions executed on the computer or the other programmable devices produce methods for implementing the functions/steps specified in the block or blocks of the flowcharts and/or the block diagrams.

### BRIEF DESCRIPTION OF THE DRAWING

Embodiments of the invention will be explained hereinafter with reference to the drawing. The drawing shows

FIG. 1A an exemplary flow diagram of an embodiment of a method according to the invention implemented on the provider side;

FIG. 1B an exemplary flow diagram of an embodiment of a method according to the invention implemented on the receiver side;

FIG. 2 a block diagram of a provider cryptosystem;

FIG. 3 a block diagram of a receiver cryptosystem;

FIG. 4 a schema of a first control algorithm and a data structure with the composite cryptographic data generated according to the first control algorithm;

FIG. 5 a schema of the application of another first control algorithm and a data structure with the composite cryptographic data generated according thereto;

FIG. 6 a schema of the application of a further first control algorithm and a data structure with the composite cryptographic data generated according thereto;

FIG. 7 an X.509 certificate as an example of a data structure containing the composite cryptographic data and associated parameters stored in specific fields.

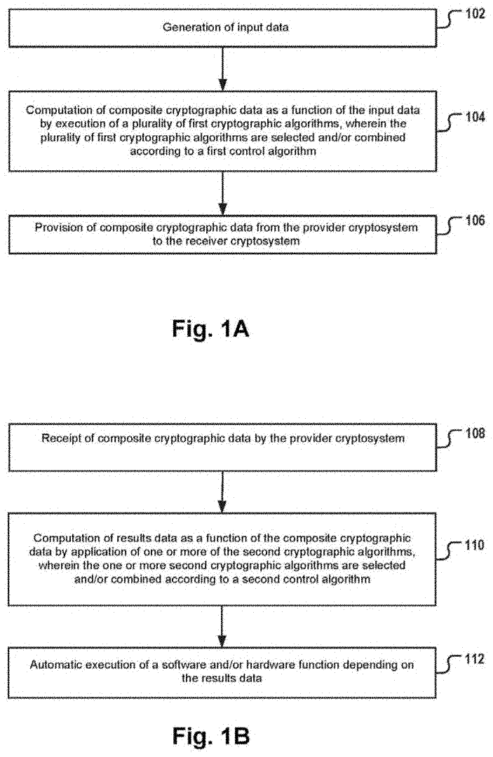

FIG. 1A shows an exemplary flow diagram of an embodiment of a method according to the invention implemented on the provider side.

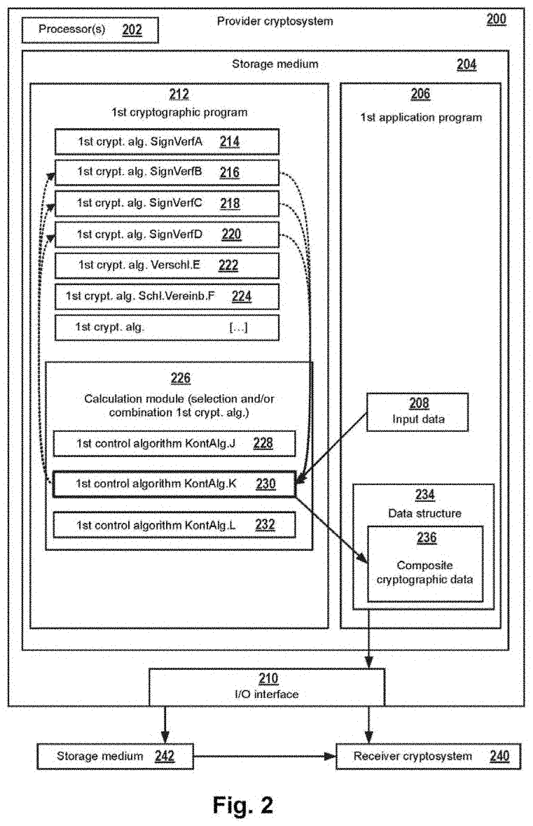

The method according to FIG. 1A may be implemented for example in a provider cryptosystem, as described by way of example for FIG. 2.

The exemplary methods according to FIG. 1A or 1B may have the advantage of supporting a great agility in the use of cryptographic algorithms, which allows cryptographic algorithms to be exchanged step-by-step even in heterogeneous multi-user systems, using a plurality of cryptographic algorithms in parallel for different IT applications. Until now, IT applications have not been prepared for the parallel or redundant use of a plurality of cryptographic algorithms, since existing, standardised data structure formats for the corresponding cryptographic data to be exchanged, in particular digital signatures, digital certificates, and/or encryption container fields for the output data and/or for the identification, provide for exactly one of these cryptographic algorithms.

In a first step 102, input data are generated or otherwise provided. The input data may be any data. For example, the input data may be an electronic document that is to be signed in order to provide the signature together with the electronic document to the receiver in order to verify the integrity of the transmitted electronic document by enabling signature verification. However, the input data may also be other data, for example cryptographic keys or other data values or data sets to be transmitted in encrypted form to the receiver cryptosystem, or random values or parameters to be used by a key agreement algorithm to derive a key in a plurality of subsequent method steps.

In step 104, the provider cryptosystem now applies not an individual cryptographic algorithm to the input data (or iteratively to the outputs of the other cryptographic algorithms), but two or more cryptographic algorithms. The cryptographic algorithms implemented on the provider side are also referred to here as “first cryptographic algorithms”. A larger number of cryptographic algorithms may be implemented in the provider cryptosystem than are actually used to generate the composite cryptographic data. The selection of these cryptographic algorithms and/or the way in which they are combined is specified in a first control algorithm. This may be implemented, for example, such that the algorithm designators of the first cryptographic algorithms and optionally some component parameters and/or control parameters are transferred as arguments to the first control algorithm, wherein the first control algorithm executes the individual cryptographic algorithms such that the component parameters associated with them are transferred as arguments.

In step 106, the composite cryptographic data computed using the plurality of first cryptographic algorithms are provided from the provider cryptosystem to the receiver cryptosystem. For example, the composite cryptographic data may be sent to the receiver cryptosystem over a network or stored in a storage medium accessible by the receiver cryptosystem. Preferably, the composite cryptographic data are provided together with an identifier of a second control algorithm and with parameters (algorithm designators of the first and, thus implicitly, also of the second cryptographic algorithms, and optionally also component parameters and/or control parameters of the second control algorithm). The parameters are also referred to as “composite parameters”.

Preferably, the composite cryptographic data are stored within a single predefined first field of a data structure agreed between the provider cryptosystem and the receiver cryptosystem. In addition, an identifier of a second control algorithm that must be used by the receiver cryptosystem to process the composite cryptographic data is stored in this data structure. This identifier may be stored, for example, together with the composite parameters in a second field.

The first field is preferably a field that is already used according to existing standards for storing cryptographic data of individual cryptographic algorithms. The second field is preferably a field that is already used according to existing standards for storing algorithm designators and optional algorithm parameters of individual cryptographic algorithms.

The storage of said composite cryptographic data and parameters in the corresponding fields may have the advantage that it is possible to specify a plurality of cryptographic algorithms within this data structure (for example certificates, signatures or key containers) via the identifier of the second control algorithm. Thus, if the receiver system is to use a different cryptographic algorithm than before, the corresponding rules and standards for signature, verification, encryption, decryption and/or key agreement do not have to be redefined and described each time. Rather, these rules are defined once generically in the form of control algorithms which are implemented on the receiver side and the identifiers of which are known to the provider cryptosystem. Thus, the specific definitions for protocols, certificates, signatures and key containers do not have to be changed each time the provider and/or receiver use a different cryptographic algorithm.

For example, each of the first control algorithms may specify a selection and/or type (for example, the order and/or mode: sequential or parallel), and also which of the first cryptographic algorithms are to be combined with each other and how, in order to obtain the composite cryptographic data. Typically, each of the first control algorithms selects only cryptographic algorithms of the same type, for example, only signature algorithms, only encryption algorithms, only key agreement algorithms, etc.

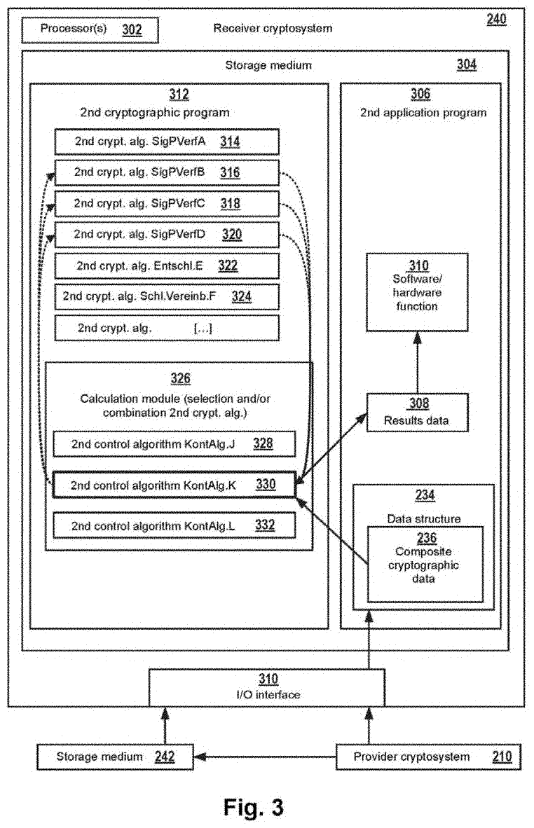

The execution of the first control algorithms by the provider cryptosystem (and analogously also the execution of the second control algorithms by the receiver cryptosystem) is preferably implemented by a software application or software module which is separate from the actual application logic (see FIGS. 2 and 3).

The output of the first control algorithm, the composite cryptographic data and optionally also the parameters, may be considered as the output of a new algorithm composed of a plurality of individual cryptographic algorithms. For each first control algorithm used on the provider cryptosystem, there is preferably a second control algorithm in the receiver cryptosystem that is functionally complementary to it. The identifier of the two functionally complementary first and second control algorithms may be identical, even if it represents different computing steps on the provider side than on the receiver side. This further reduces the effort of converting existing single-algorithm cryptosystems to cryptosystems that support the generation of composite cryptographic data (hybrid-algorithm cryptosystems), since the use of identical identifiers for different computing steps of a multi-sided cryptographic procedure on the provider side and the receiver side is already implemented in today's cryptosystems. Thus, the control algorithm identifiers and the associated composite cryptographic data may be processed by upstream programs at the application level in the same way and “passed through” to crypto modules or crypto programs, as is already done today with the identifiers and cryptographic data of individual cryptographic algorithms.

FIG. 1B shows an exemplary flow diagram of an embodiment of a method according to the invention implemented on the receiver side.

The method according to FIG. 1B may be implemented for example in a receiver cryptosystem, as described by way of example for FIG. 3.

In a first step 108, the receiver cryptosystem receives the composite cryptographic data. For example, it receives the data directly from a provider cryptosystem, for example via a network, or reads the data from a storage medium.

In a next step 110, the receiver cryptosystem processes the composite cryptographic data to obtain results data. The composite cryptographic data are processed using one or more second cryptographic algorithms. The selection and/or coordination and combination of the one or more second cryptographic algorithms is performed by a “second” control algorithm which is implemented on the receiver side and which preferably receives the algorithm designators of the second cryptographic algorithms as arguments. The algorithm designators may be read from the data structure, for example with optionally additionally present control parameters and/or component parameters. Preferably, this second control algorithm is determined by an identifier received together with the composite cryptographic data and determined by the provider cryptosystem. It is possible that only an individual second cryptographic algorithm is used to process the composite cryptographic data, even though a plurality of first cryptographic algorithms have been used to compute the composite cryptographic data (for example, in the case of “OR” control algorithms).

Lastly, in step 112, the receiver cryptosystem automatically executes a software and/or hardware function depending on the results data.

For example, the composite cryptographic data could be the input data in encrypted form and the results data could be the decrypted, reconstructed input data. The automatic software and/or hardware function could include outputting the reconstructed, decrypted data to a user or storing the data in decrypted form.

According to another example, the composite cryptographic data could be a composite signature of an electronic document or its hash value, and the results data could be the result or results of one or more signature verification processes. Depending on this result, the electronic document could be considered trustworthy and forwarded or stored for further processing, or discarded as tampered. Additionally or alternatively, it is also possible that in case of the result that the signature is valid, a mechanical locking mechanism is opened or released. For example, the verified signature could be the signature of a user's identity document, and the signature verification could be performed as part of an authentication procedure, for example to grant access to a protected area or room and/or to grant access to software functions or data.

According to another example, the composite cryptographic data could be a final key agreed upon in the course of a key agreement procedure between the provider cryptosystem and the receiver cryptosystem. This final key may now be used, for example, to establish a cryptographically secured communication channel between the provider cryptosystem and the receiver cryptosystem.

According to another example, the composite cryptographic data is a key container comprising a plurality of different cryptographic keys which are made available again individually by the second control algorithm and/or are used according to their respective functions, for example to encrypt or decrypt data, to sign data, to verify signatures, etc.

FIG. 2 shows a block diagram of a provider cryptosystem 200. The provider cryptosystem may be implemented, for example, as a standard computer system, server computer system, distributed cloud computer system, or other data processing system. The cryptosystem 200 comprises one or more processors 202 and a volatile or non-volatile storage medium 204.

Preferably, the storage medium comprises at least one application program 206, for example an e-mail program for processing S/MIME data, and a first cryptographic program 212. The first application program and the first cryptographic program are operatively coupled to each other by a data exchange interface. It is also possible that the first cryptographic program is a program library or a program module integrated into the first application program.

The first cryptographic program 212 comprises a plurality of first cryptographic algorithms 214-224. The first cryptographic algorithms may all be of the same type or may belong to different types. For example, the first cryptographic algorithms 214-220 each implement a different signing procedure. The first cryptographic algorithm 222 is an encryption algorithm and the first cryptographic algorithm 224 is a key agreement algorithm.

The cryptographic program comprises a computation module 226 that includes or may read one or more first control algorithms 228-232. Each of these first control algorithms specifies a selection and/or a combination (in the sense of how the algorithms and/or the outputs of the algorithms are to be combined) of a plurality of first cryptographic algorithms, wherein preferably only first cryptographic algorithms of the same type are combined.

A variety of first and complementary second control algorithms are possible, preferably identified by the same identifier, such as:

SIGNATURE AND: here, a composite signature is generated by computing a signature by each of the signature algorithms selected by the first control algorithm and subsequently combining (for example concatenating) these signatures to form a composite signature. The verification (to be performed by the receiver cryptosystem) of a SIGNATURE AND control algorithm implemented on the receiver side returns as results data that the composite signature is valid if all signatures of the individual signatures used to generate the composite signature are valid.

SIGNATURE OR: here, as with SIGNATURE AND, a composite signature is generated by computing a signature by each of the signature algorithms selected by the first control algorithm and subsequently combining these signatures to form a composite signature. The verification (to be performed by the receiver cryptosystem) of a SIGNATURE OR control algorithm implemented on the receiver side returns as results data that the composite signature is valid if at least one signature of the plurality of signatures used to generate the composite signature is valid.

SIGNATURE K-of-N(K>0; N>=K): here, a composite signature is generated by computing a signature by each of the N signature algorithms selected by the first control algorithm and subsequently combining these signatures to form a composite signature. The verification (to be performed by the receiver cryptosystem) of a SIGNATURE K-of-N control algorithm implemented on the receiver side returns as results data that the composite signature is valid if at least K of the signatures of the N signatures used to generate the composite signature is valid.

KEY AGREEMENT XOR: The keys agreed with the individual first cryptographic key agreement algorithms are padded or shortened to a common length and then connected to XOR to form a final key. The final key represents the composite cryptographic data and is used as the cryptographic key ultimately agreed between the provider cryptosystem and the receiver cryptosystem. The receiver computer system cryptosystem must implement any key agreement algorithms (in the form of second cryptographic algorithms) that are functionally complementary to the key agreement procedures used by the provider cryptosystem as first cryptographic algorithms to generate the final key. Otherwise, the key agreement between the provider cryptosystem and the receiver cryptosystem fails.

KEY ENCRYPTION SEQUENTIAL: A symmetric key is encrypted with a first cryptographic algorithm, which is a specific encryption algorithm. The ciphertext is then encrypted again with a further first cryptographic algorithm that implements a different encryption algorithm. The resulting ciphertext is then encrypted with a further first cryptographic algorithm that implements a further different encryption key. And so on. The output of the last-executed encryption algorithm is provided as the composite cryptographic data. The decryption (to be performed by the receiver cryptosystem) of a ciphertext generated according to the first control algorithm KEY

ENCRYPTION SEQUENTIAL involves the application of functionally complementary decryption keys in inverse order to the ciphertext received from the provider cryptosystem. Provided the receiver cryptosystem implements all the required decryption algorithms and has the necessary decryption keys, it is able to reconstruct the original input data and use it as results data.

KEY CONTAINER: here, a composite key is generated by concatenating keys identified and/or computed by the algorithms selected by the first control algorithm. The composite key may be formed, for example, by concatenation. The second control algorithm, which is functionally complementary to this first control algorithm, extracts the individual keys from the container and preferably also applies them according to their type in a cryptographic procedure.

Each of the first control algorithms may therefore itself be regarded as a new, cryptographic algorithm composed of a plurality of (first) cryptographic algorithms.

Against the background of the growing spread of quantum computers, many new algorithms are being developed that may still contain security problems due to the short time required for cryptographic analysis or may be implemented incorrectly due to their complexity. These new algorithms may be combined—also together with the known algorithms—by means of one or more initial control algorithms. Even if a component algorithm used were to be considered broken, the composite cryptographic data (for example a composite signature) would be able to be correctly verified or processed with at least one component algorithm that is still secure (at least when the first cryptographic algorithms are used in parallel, not sequentially).

Since the rules for composing cryptographic algorithms are stored in separately stored and processed control algorithms on the provider and/or receiver side, it is possible to achieve great cryptographic agility. Thus, the operator of a provider cryptosystem configured for signature creation may, for example in the case of signature OR, add further new signature algorithms of which the signatures are included in the composed cryptographic data, even if it is known that not all receivers have yet mastered the new signature algorithm (i.e. are able to verify corresponding signatures).

For example, in the example shown here, the computation module 226 may comprise a first control algorithm 228 according to SIGNATURE AND, a further first control algorithm 230 according to SIGNATURE OR, and a further first control algorithm 232 according to KEY ENCRYPTION SEQUENTIAL.

The first application program could provide input data 208, for example an electronic document such as an email, to the first cryptographic program 212. The provision may optionally include a specification of which of the first control algorithms should be used to generate a signature for the electronic document. The first cryptographic program receives the input data 208 and performs, for example, the first control algorithm 230 (SIGNATURE OR).

Within the first control algorithm 230, it is specified that the one signature of the input data 208 or of a hash value of the input data is to be computed. Furthermore, the control algorithm 230 provides for a combination of the three generated signatures, for example by concatenating the individual signatures. The individual signatures may be separable from each other, for example by means of predefined separators (delimiters), by predefined maximum lengths or in any other way. The concatenate of signatures thus obtained is stored as the composite cryptographic data 236 in a data structure 234 and returned to the first application program 206. In addition, an identifier of the second control algorithm to be used to process the composite cryptographic data 236 is written to the data structure 234.

Lastly, the provider cryptosystem 200 is configured to provide the data structure containing the composite cryptographic data 236 and the identifier of the second control algorithm (SIGNATURE OR) to the receiver cryptosystem 240. According to some implementation variants, the provider cryptosystem includes an interface 210 to send the data structure 234 directly to the receiver cryptosystem 240. However, in addition or alternatively, the provider cryptosystem may also include an interface for storing the data structure 234 in a storage medium 242. The storage medium 242 is a storage medium to which the receiver cryptosystem has current or future read access.

FIG. 3 shows a block diagram of a receiver cryptosystem 240.

The receiver cryptosystem 240 comprises one or more processors 302 and a volatile or non-volatile storage medium 304. The receiver cryptosystem may take the form of a wide variety of data-processing systems as already described for the provider cryptosystem.

The cryptosystem 240 comprises one or more processors 302 and a volatile or non-volatile storage medium 304.

The receiver cryptosystem comprises an interface 310 for receiving the composite cryptographic data. For example, the composite cryptographic data may be received as part of a data structure 234, wherein the data structure may be a standard data structure, for example an X.509 certificate. The interface 310 may be, for example, an interface for receiving a data structure 234 from the provider cryptosystem over a network or an interface for reading the data structure 234 from a storage medium 242.

Preferably, the storage medium comprises at least one application program 306, for example an e-mail program for processing S/MIME data, and a cryptographic program 312. The application program 306, also referred to as the “second application program”, and the “second” cryptographic program 312 are operatively coupled to each other by a data exchange interface. It is also possible that the second cryptographic program is a program library or a program module integrated into the second application program.

The second cryptographic program 312 comprises a plurality of second cryptographic algorithms 314-324. The second cryptographic algorithms may all be of the same type or may belong to different types. For example, the second cryptographic algorithms 314-320 each implement a different signature verification procedure. The second cryptographic algorithm 322 is a decryption algorithm and the second cryptographic algorithm 324 is a key agreement algorithm. For example, each of the second algorithms may be functionally complementary to a first algorithm 214-224 of the provider cryptosystem. It is also possible for the second algorithms of a receiver cryptosystem to be functionally complementary to a set of first algorithms stored in a distributed manner in different provider cryptosystems. This may have the advantage that the receiver cryptosystem may equally process composite cryptographic data that are generated by a plurality of different provider cryptosystems with a different set of first cryptographic algorithms.

The cryptographic program comprises a computation module 326 that includes or may read one or more second control algorithms 328-332. Each of these second control algorithms specifies a selection and/or a combination (in the sense of how algorithms and/or the outputs of the algorithms are to be combined) of a plurality of second cryptographic algorithms, wherein preferably only second cryptographic algorithms of the same type are combined.

The second control algorithms are preferably functionally complementary to a first control algorithm, for example one of the control algorithms described with reference to FIG. 2, such as SIGNATURE AND, SIGNATURE ODER, etc.

The computation module is configured to receive and evaluate the data structure 234 from the application program. The data structure also contains, in addition to the composite cryptographic data, an identifier of a second control algorithm, here for example of control algorithm 330, and hereby determines the second control algorithm to be executed by the receiver cryptosystem in response to the receipt of the data structure.

The selected second control algorithm is a SIGNATURE OR control algorithm that is functionally complementary to the first control algorithm 230 (SIGNATURE OR) that created the composite cryptographic data 236.

Preferably, the received data structure contains parameters in addition to the identifier of the second control algorithm 330. These parameters may specify algorithm designators and optionally also parameters of the individual second cryptographic algorithms 316, 318 and 320 (“component parameters”) used by the second control algorithm to process the composite cryptographic data to obtain the results data 308. The parameters may also specify, for example, delimiters or maximum character sequence lengths that separate the cryptographic data generated by the individual first cryptographic algorithms, or other parameters that directly control the execution of the second control algorithm (“control parameters”). For example, if the selected second control algorithm is a SIGNATURE OR algorithm, the results data 308 would specify that the composite signature 236 is valid if any of the signatures generated by the first cryptographic algorithms, as verified by a corresponding signature verification algorithm 316-320, indicates that the signature is valid.

According to preferred examples of the invention, the composite cryptographic data 236 is stored in a data structure 234 of which the structure has been agreed between the provider cryptosystem and the receiver cryptosystem. This means that both cryptosystems agree on which data are or will be stored in which field of the data structure. The agreement may preferably be based on the fact that the structure of the data structure is defined in a (conventional) standard.

Preferably, the second control algorithm parameters stored in the data structure 234 together with the identifier of the second control algorithm include algorithm designators and optionally also component parameters of one or more second cryptographic algorithms to be selected and/or combined by the second control algorithm. The parameters may also include control parameters of the second control algorithm. The manner in which a first and/or second cryptographic algorithm is executed and/or the official algorithm designator is typically specified in cryptographic standards.

According to one example, a first and/or second cryptographic algorithm may be a variant of RSA. Different variants of RSA and their designators (algorithm designators) are described, for example, in the RFC 8017 standard.

According to a further example, a first and/or second cryptographic algorithm may be the ECDSA algorithm described in the ANSI X9.62 standard.

For example, the first and/or second control algorithms include, receive and/or use parameters. The parameters comprise algorithm designators of the individual first or second cryptographic algorithms selected and/or combined by those control algorithms, wherein the parameters optionally also include component parameters of those cryptographic algorithms and/or control parameters used directly by the control algorithms. Preferably, the algorithm designators and component parameters are defined according to existing conventional standards.

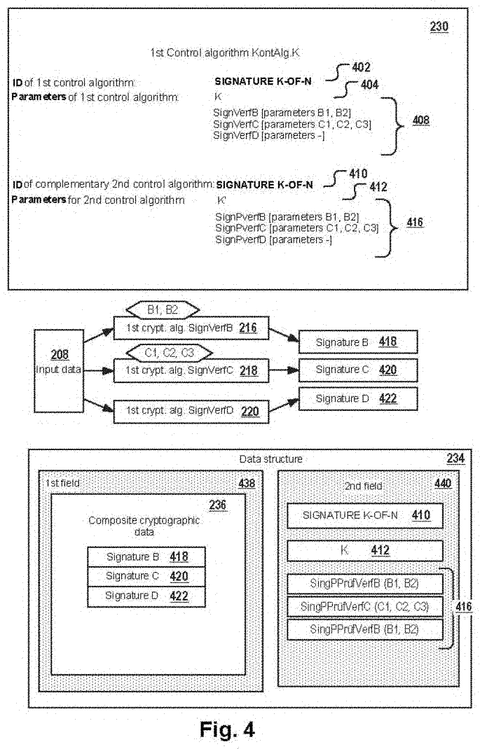

Preferably, the identifier of the second control algorithm and all of the above-mentioned parameters used by this second control algorithm are stored in the fields of a standardised cryptographic data structure provided for individual cryptographic algorithms according to existing standards. The identifier and the parameters may be designated for example according to ASN.1 notation explained with respect to FIG. 4. This has the advantage that the application-level program receiving such a cryptographic data structure, possibly already partially processed and transferring the extracted identifiers, parameters and cryptographic data to a cryptographic module, does not need to be rewritten. This is because the structure of the fields of the data structure has not changed. Only the cryptographic module that ultimately performs the cryptographic operations needs to know that the “algorithm identifier” includes the identifier of a second control algorithm, not the algorithm designator of an individual cryptographic algorithm. And it must know that, for example, in the field ::=SEQUENCE there are contained composite cryptographic data, not cryptographic output data of an individual cryptographic algorithm.

```
AlgorithmIdentifier ::= SEQUENCE {
  algorithm OBJECT IDENTIFIER,
  parameters ANY DEFINED BY algorithm OPTIONAL }
```

In a data structure 234 specified according to ASN.1, the second control algorithm is specified according to the above-mentioned statement: The identifier of the second control algorithm, for example “SIGNATURE OR”, is given an OID in the same format as the OIDs of individual cryptographic algorithms, that is to say for example “1.2.3.4.5.6.7.8.9”. The parameters would be: “SIGNATURE OR param::=SEQUENCE OF Algorithmldentifier”, wherein Algorithm Identifier uses the values of a plurality of signature algorithms used as second cryptographic algorithms, which again each consist of OID and parameters.

The storing, as described here for embodiments, of the composite cryptographic data in a predefined first field and of the identifier of the second control algorithm and associated second parameters in a second field, that serve to store cryptographic data or algorithm designators of a single cryptographic algorithm, respectively, according to conventional data structure standards, may have the advantage that the processing application software of the receiver cryptosystem “knows” how to read the composite cryptographic data and the identifier of the second control algorithm and forward same to the cryptographic software.

In a further advantageous aspect, standard conformity may be achieved very simply by specifying for each composite algorithm (with its own OID) in the corresponding definition (possibly published as a standard) how the keys, signatures and ciphertexts are to be handled. For example, composite keys and composite signatures, i.e. keys or signatures composed of two or more keys or signatures, may be simple concatenations of the individual keys and signatures generated by the first cryptographic algorithms. In the case of the data encryption iterative, the ciphertext is the result of the last-performed component encryption.

FIG. 4 shows a schema of a first control algorithm and a data structure with the composite cryptographic data generated according to the first control algorithm.

For example, in the first control algorithm, an identifier 402 of the first control algorithm and an identifier 410 of the second control algorithm to be used to process the generated composite cryptographic data are predetermined. The identifiers 402 and 410 are typically identical, but may also be different in some embodiments.

The first control algorithm is preferably configured to use as input and/or to output a set of parameters 404, 408, 412, 416.

For example, the parameters 408 comprise algorithm designators of those first cryptographic algorithms to be used to generate the composite cryptographic data, component parameters optionally required by them (for example B1, B2 for signature algorithm/signature verification algorithm B, component parameters C1, C2 and C3 for signature algorithm/signature verification algorithm C, the signature algorithm/signature verification algorithm D does not require component parameters) and optionally also control parameters 404, 412 for the first (and possibly also for the functionally corresponding second) control algorithm itself.

For example, a control parameter 404, 410 at SIGNATURE K-of-N could specify the value K from the set of first cryptographic algorithms. The value K is a number less than or equal to N and specifies the minimum number of signatures that must be verified as valid for the composite signature verification performed by the second control algorithm in its entirety to result in a signed document being valid. For example, in the case of KEY AGREEMENT, the bit length to which the results of the individual algorithms must be shortened or padded may be used as a control parameter. How the first and/or second algorithms are to be combined is specified by the identifier of the first or second control algorithm, for example AND/OR/AGGREGATE/etc.

For example, in the example shown in FIG. 4, N may be 3 and K may be 2, for example. This means that the three signing procedures B, C and D denoted by the algorithm designators are each applied to the input data 208, for example a document to be signed, wherein the algorithms B and C use component parameters B1, B2, C1, C2, C3. The obtained signatures 418, 420, 422 are concatenated and stored as the composite cryptographic data 236 in, for example, a first field 438 of a data structure 234 which is an X.509 certificate. The identifier 410 of the second control algorithm and a plurality of parameters 412, 416 to be used by the second control algorithm are stored in a second field 440 of the data structure. The parameters include the algorithm designators B, C and D, the component parameters B1, B2, C1, C2, C3 and the control parameter K=2.

This allows cryptosystems that use X.509 certificates to be prepared and converted to quantum-computer-secure cryptographic procedures. Since it is not yet completely certain which classes of cryptographic procedures may also be considered secure against quantum computer attacks in the long term, it may be advantageous to use a plurality of quantum-computer-secure cryptographic procedures from different mathematical problem classes as well as one or more conventional cryptographic procedures to generate the composite cryptographic data.

This has the advantage that the composite signatures, ciphertext and/or keys generated on the basis of such a combination of conventional and new cryptographic algorithms may also be used by applications that have not yet implemented quantum-computer-secure cryptographic methods.

Various examples of a data structure 234 for storing the composite cryptographic data and the identifier of the second control algorithm are described below.

In the following, various groups of embodiments a)-d) for a data structure containing the composite cryptographic data and control algorithm identifiers and a method for storing these data in a data structure are described. Here, certain control algorithms or composite cryptographic data formed/to be processed by them are listed by way of example, for example composite signatures. Alternatively, however, any other of the control algorithms described here and the composite cryptographic data formed by them may also be used, in particular, for example, “SIGNATURE AND”, “SIGNATURE OR”, “SIGNATURE K-of-N”, “KEY AGREEMENT AGGREGATE”, “DATA ENCRYPTION ITERATIVE”, “DATA ENCRYPTION-PARALLEL”, “KEY CONTAINER”.

a) X.509 Certificates

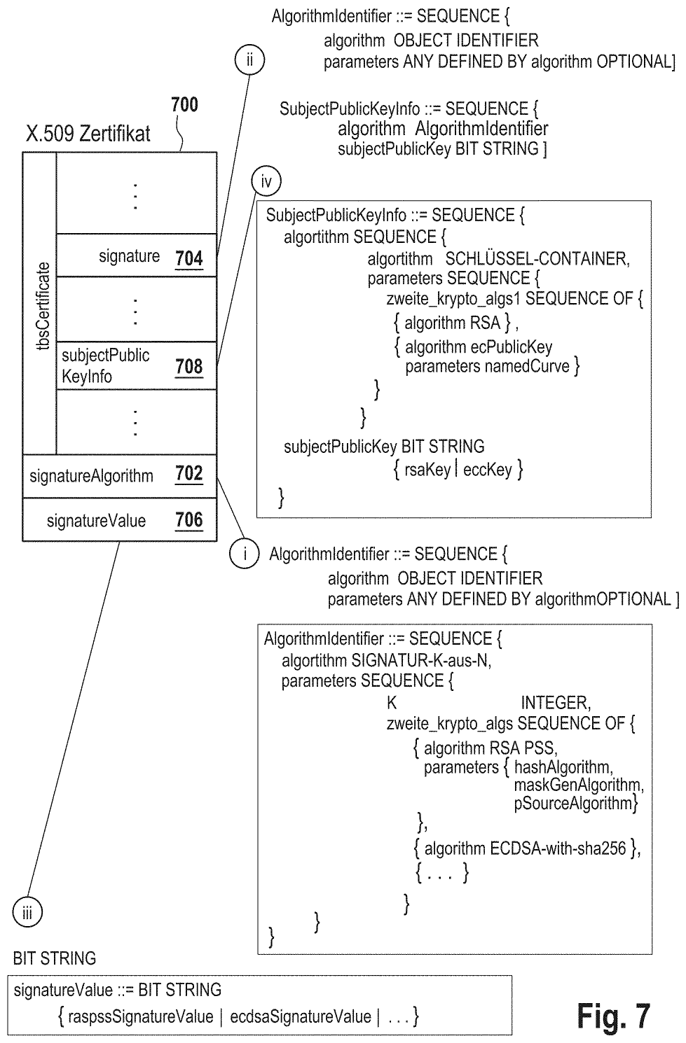

For example, the composite cryptographic data and/or the identifier of the second control algorithm in X.509 certificates may be stored in the following certificate areas or fields i, ii, iii and/or iv, which are currently used to store cryptographic data and algorithm designators of individual cryptographic algorithms. An example of a corresponding certificate 700 is shown in FIG. 7, to which reference is also made here:
i. signatureAlgorithm field 702, 440: this field specifies, according to a conventional cryptographic standard (see RFC 5280, 4.1.1.2), which algorithm is used by the Certification Authority (CA) to sign the certificate. The formal description in ASN.1 is:

```
AlgorithmIdentifier ::= SEQUENCE {
  algorithm OBJECT IDENTIFIER,
  parameters ANY DEFINED BY algorithm OPTIONAL }.
```

Thus, according to embodiments of the invention, the certificate 234 would contain the following information in the signatureAlgorithm field 440:

| SEQUENCE{ | |
|---|---|
| algorithm SIGNATURE K-of-N, | |
| parameters SEQUENCE { | |
| K | INTEGER, |
| second_crypto_algs | SEQUENCE OF |

```
  AlgorithmIdentifier
  }
}
```

Thus, in the field “AlgorithmIdentifier”, the input area “algorithm” would contain an ID of the second control algorithm, for example “SIGNATURE K-of-N” and in the input area “parameters” there would be stored the control parameter(s) of the control algorithm, for example the value K, and the sequence of algorithm designators of the second cryptographic algorithms to be used, for example “RSA PSS” or “ECDSA” 416. If some of the second cryptographic algorithms themselves require parameters for their description, these are included in the recursively used description of second_crypto_algs as “Algorithm Identifier”. (In this example, N does not need to be specified as a parameter of the control algorithm because the value N results from the number of second cryptographic algorithms listed in second_crypto_algs. The entire data structure signatureAlgorithm then looks like this in this example for the second control algorithm “SIGNATURE K-of-N”:

```
AlgorithmIdentifier ::= SEQUENCE {
  algorithm SIGNATURE K-of-N,
  parameters SEQUENCE {
    K INTEGER,
    second_crypto_algs SEQUENCE OF {
      {algorithm RSA PSS,
        parameters { hashAlgorithm,
          maskGenAlgorithm,
          pSourceAlgorithm}
      },
      {algorithm ECDSA-with-sha256},
      { . . . }
    }
  }
}
```

ii. In the certificate field “signature” 704, there must be the same content as in field (i) “signatureAlgorithm”; see RFC 5280, 4.1.1.2.
iii. SignatureValue field (see RFC 5280, 4.1.1.3) 706, 438: This is a field 438 for storing the signature of the certification authority on the content of the certificate with the signatureAlgorithm algorithm and the private key of the certification authority. The formal description in ASN.1 is: signatureValue BIT STRING.
   According to embodiments of the invention, the certificate 234 would thus contain in the first field 438, in said standard, the field signatureValue, the composite cryptographic data resulting from the signature with the control algorithm and its parameters mentioned under (i) and (ii). In the stated example of a SIGNATURE K-of-N, this is the stringing together of the results of the individual first cryptographic algorithms, also represented as a BIT STRING. The resulting SEQUENCE OF BIT STRING is preferably subjected to a type conversion to BIT STRING. The entire data structure signatureValue then looks like this:

signatureValue ::= BIT STRING
{raspssSignatureValue | ecdsaSignatureValue | . . . }

iv. SubjectPublicKeyInfo field (see RFC 5280, 4.1.2.7) 708: This is a certificate area for storing the public key of the certificate holder and an algorithm designator of the cryptographic algorithm with which this key may be used. The cryptographic algorithm may be, for example, a signature algorithm or an algorithm of another algorithm type.
   According to embodiments of the invention, a plurality of keys of the same or different algorithms are associated with an entity in the certificate. The field subjectPublicKeyInfo is of type SubjectPublicKeyInfo which is defined as

| | |
|---|---|
| SubjectPublicKeyInfo ::= | SEQUENCE { |
| algorithm | AlgorithmIdentifier, |
| subjectPublicKey | BIT STRING } |

According to embodiments of the invention, the certificate in this area would contain a first field 438 and identify it by the term “subjectPublicKey” and would contain a second field 440 and identify it by the term “algorithm”. The second field contains the ID of the control algorithm KEY-CONTAINER and as parameters the algorithms of the various keys contained as concatenation in the first field. In the present example, this certificate area 708 would therefore contain the following information:

SubjectPublicKeyInfo ::= SEQUENCE {

| | |
|---|---|
| algorithm | “KEY CONTAINER and parameters”, |
| subjectPublicKey | [composite cryptographic data] } |

Since algorithm from SubjectPublicKeyInfo is of type
AlgorithmIdentifier ::= SEQUENCE {

| | |
|---|---|
| algorithm | OBJECT IDENTIFIER, |
| parameters | ANY DEFINED BY algorithm OPTIONAL } |

it is again defined by the identifier of the control algorithm KEY CONTAINER and the parameters. The parameters again consist of the sequence of algorithm designators of the first cryptographic algorithms and optionally their respective parameters.

```
algorithm ::= SIGNATURE OR identifier
  parameters ::= SEQUENCE {
  sequence_key_algorithms SEQUENCE OF AlgorithmIdentifier
}
```

The composite cryptographic data in this case are the stringing together of public keys assigned to the entity in the certificate and the sequence key algorithms in that sequence matching the algorithm designators named in parameters. The composite cryptographic data are stored in the field subjectPublicKey from subjectPublicKeyInfo and result in KEY-CONTAINER as SEQUENCE OF BIT STRING and are still subjected to a type conversion to BIT STRING. The entire data structure signatureValue then looks like this:

```
SubjectPublicKeyInfo ::= SEQUENCE {
  algorithm SEQUENCE {
    algorithm KEY CONTAINER,
    parameters SEQUENCE {
      second_crypto_algs1 SEQUENCE OF {
        { algorithm RSA},
        { algorithm ecPublicKey
          parameters namedCurve}
      }
    }
  subjectPublicKey BIT STRING
    {rsaKey | eccKey}
}
```

It is therefore possible to use composite cryptographic data within conventional X.509 certificates in the same way as the cryptographic data already contained previously in these certificates. Nothing needs to be changed in the certificate standards and/or the application programs that receive and parse the certificates, unless these programs also implement the actual cryptographic algorithms used to process the certificate.

For example, X.509 certificates with composite cryptographic data may be processed in a standard-compliant manner according to the following standards:
ITU-T X.509 (10/2019) Information technology—Open Systems Interconnection—The Directory: Public-key and attribute certificate frameworks
(identical to ISO/IEC 9594-8)
RFC 5280: Internet X.509 Public Key Infrastructure Certificate and Certificate Revocation List (CRL) Profile, May 2008

In certificates, it is even possible to use composite cryptographic data for two purposes: a) in signing the certificates and b) in assigning keys to the certificate holder.

In case a), the identifier of the second control algorithm in an X.509 certificate is stored for example in the algorithm field of the signatureAlgorithm field as OBJECT IDENTIFIER, the parameters of the second control algorithm as well as the algorithm designators of the second cryptographic algorithms including their parameters are stored in the parameters field of the signatureAlgorithm field. (The signature field of the tbsCertificate field contains the same information as the signatureAlgorithm field). The composite cryptographic data are stored in the signatureValue field.

In case b), the identifier of the second control algorithm in an X.509 certificate is stored for example in the algorithm field of the field algorithm of the subjectPublicKeyInfo field as OBJECT IDENTIFIER, the parameters of the second control algorithm as well as the algorithm designators of the second cryptographic algorithms including their parameters are stored in the parameters field of the field algorithm of the subjectPublicKeyInfo field. The composite cryptographic data are stored in the subjectPublicKey field of the subjectPublicKeyInfo field.

The example shown in FIG. 7 is intended to illustrate that it is possible to store the composite cryptographic data of a plurality of first control algorithms in the same certificate. However, it is also possible that, for example, only the certificate area iv or only the certificate fields i-iii contain composite cryptographic data or identifiers of control algorithms together with composite parameters and the other areas of the certificate contain conventional cryptographic data, identifiers and parameters of only a single conventional cryptographic algorithm.

b) File Signatures and Encrypted Files According to CMS

Composite cryptographic data may also be stored and read in data structures according to the Cryptographic Message Syntax (see RFC 5652: Cryptographic Message Syntax (CMS), September 2009)) without having to change anything in the standard.

For the signature of data, the signed-data content type is used in CMS; see RFC 5652, section 5). The signatures of the individual signatories are each contained in a data structure area of type SignerInfo designated as “signerInfo”.

```
SignerInfo ::= SEQUENCE {
  version CMSVersion,
  sid SignerIdentifier,
  digestAlgorithm DigestAlgorithmIdentifier,
  signedAttrs [0] IMPLICIT SignedAttributes OPTIONAL,
  signatureAlgorithm SignatureAlgorithmIdentifier,
  signature SignatureValue,
  unsignedAttrs [1] IMPLICIT UnsignedAttributes OPTIONAL }
```

In this data structure area SignerInfo, the identifier of the control algorithm, its control parameters and, as further parameters, the algorithm designators of the second cryptographic algorithms together with their component parameters may be inserted into the field 440 signatureAlgorithm. Typically, the identifier of the control algorithm is a SIGNATURE OR, a SIGNATURE AND or a SIGNATURE K-of-N. The composite cryptographic data in this case comprise a stringing together of the results of the individual first cryptographic algorithms, which have still undergone type conversion to OCTET STRING. The composite cryptographic data are inserted in field 438 “signature” of the data structure area SignerInfo.

CMS uses the enveloped-data content type for encrypting data (see RFC 5652, section 6). A content-encryption key is randomly generated for (for example symmetric) file encryption and the content-encryption key is encrypted individually (for example asymmetrically) for each receiver. For each receiver, a data set of the type RecipientInfo is contained in the data of the enveloped-data content type. This data structure area may have an area designated as KeyTransRecipientInfo, KeyAgreeRecipientInfo and other areas of analogous function.

KeyTransRecipientInfo:

```
KeyTransRecipientInfo ::= SEQUENCE {
  version CMSVersion, -- always set to 0 or 2
  rid RecipientIdentifier,
  keyEncryptionAlgorithm KeyEncryptionAlgorithmIdentifier,
  encryptedKey EncryptedKey }
```

In the expression KeyTransRecipientInfo, the identifier of the control algorithm, its control parameters and, as further parameters, the algorithm designators of the second cryptographic algorithms together with their component parameters are used in the field 440 “keyEncryptionAlgorithm” there. For example, the identifier of the control algorithm may be a DATA ENCRYPTION ITERATIVE. The composite cryptographic data comprise the results of the successively executed first cryptographic algorithms, which have still been subjected to a type conversion to OCTET STRING. The composite cryptographic data will be inserted in field 438 “encryptedKey” of the data structure.

KeyAgreeRecipientInfo:

```
KeyAgreeRecipientInfo ::= SEQUENCE {
  version CMSVersion, -- always set to 3
  originator [0] EXPLICIT OriginatorIdentifierOrKey,
  ukm [1] EXPLICIT UserKeyingMaterial OPTIONAL,
  keyEncryptionAlgorithm KeyEncryptionAlgorithmIdentifier,
  recipientEncryptedKeys RecipientEncryptedKeys }
```

In the expression KeyAgreeRecipientInfo, the identifier of the control algorithm, its control parameters and, as further parameters, the algorithm designators of the second cryptographic algorithms together with their component parameters are stored in the field “keyEncryptionAlgorithm” there. For example, a KEY AGREEMENT AGGREGATE may be used as the identifier of the control algorithm. Here there are two fields 438 with composite cryptographic data.

a) The public key used for the key agreement, which is generally ephemeral, is contained in the substructure originatorKey of the type OriginatorPublicKey of the structure originator (see in particular RFC 5652, 6.2.2).

```
OriginatorPublicKey ::= SEQUENCE {
  algorithm AlgorithmIdentifier,
  publicKey BIT STRING }
```

The OriginatorPublicKey structure contains the algorithm field of type Algorithmldentifier. According to embodiments of the invention, this field contains the identifier of the control algorithm, optionally its control parameters and the sequence of algorithm designators of the second cryptographic algorithms. For example, the identifier of the control algorithm KEY-CONTAINER may be used. The composite cryptographic data in this case are the stringing together of the public keys in the order in which they are named in the control algorithm parameters.

b) The encryption key used for encryption is contained in the field recipientEncryptionKeys, for a receiver of type recipientEncryptionKey (see in particular RFC 5652, 6.2.2).

```
RecipientEncryptedKey ::= SEQUENCE {
  rid KeyAgreeRecipientIdentifier,
  encryptedKey EncryptedKey}
```

According to this embodiment, the encryptedKey key is computed by the first control algorithm designated in the keyEncryptionAlgorithm field from the KeyAgreeRecipientInfo structure, involving the first cryptographic algorithms mentioned in the parameters and the keys designated and specified under a). The composite cryptographic data thus computed with the control algorithm—the encryption key—is the result of an aggregation (for example with XOR) of the results of the executed first cryptographic algorithms. The composite cryptographic data are stored in the recipientEncryptedKey field of the KeyAgreeRecipientInfo data structure.

According to embodiments, the Cryptographic Message Syntax (CMS) data structure is used to prove or verify the accuracy and integrity of passports and other travel documents. Standards describing the nature of documents and their electronic data include, for example, ICAO Doc 9303, Machine Readable Travel Documents, Seventh Edition, 2015, Part 11: Security Mechanisms for MRTDs, and ICAO Doc 9303, Machine Readable Travel Documents, Seventh Edition, 2015, Part 12: Public Key Infrastructure for MRTDs.

These travel documents (Machine-Readable Travel Documents—MRTD) contain electronic data of which the integrity may be determined by checking the signature in the Document Security Object (SOD). The signature corresponds to the signature of documents according to CMS (RFC 5652), that is to say it is an example of a file signature that is frequently used and the conversion of which to quantum-secure signatures may be carried out by means of storing composite cryptographic signatures and related data in the fields mentioned above.

According to further embodiments, the Cryptographic Message Syntax (CMS) data structure is used to prove or verify the correctness and integrity of identity cards, in particular the German identity card and German residence permits. The correctness and integrity of the electronic data stored in German identity cards and residence permits is determined by checking the signature in the Document Security Object (SOD), in the file EF.CardSecurity or in the file EF.ChipSecurity, depending on the IT application used. The signature corresponds to the signature of documents RFC 5652.

Relevant standards for the ID card are for example Technical Guideline TR-03127, eID Cards with eID and eSign Application based on Extended Access Control, Identity Card and Electronic Residence Permit, Version1.21, Federal Office for Information Security, 2 May 2018, and Technical Guideline TR-03110, Advanced Security Mechanisms for Machine Readable Travel Documents and eIDAS Token—Part 3: Common Specifications, Version 2.21, Federal Office for Information Security, 21 Dec. 2016.

c) Certificate Requirements

Certificate requirements contain the technical part of a certificate request with which the applicant requests a certificate from a certification authority. It is often referred to as PKCS #10 because the first standard for such certificate requests was Standard #10 from the Public Key Cryptography Standards series of RSA Laboratories (today one uses RFC 2986: PKCS #10: Certification Request Syntax Specification, Version 1.7, November 2000). A PKCS #10 certificate request according to RFC 2986 looks like this:

```
CertificationRequest ::= SEQUENCE {
  certificationRequestInfo CertificationRequestInfo,
  signatureAlgorithm AlgorithmIdentifier{{ SignatureAlgorithms }},
  signature BIT STRING
}
```

As in the later certificate, the following information is included or the following fields are provided in a certificate request.
i. signatureAlgorithm: denotes, analogously to field 702 in the X.509 certificate, the algorithm with which the content of the PKCS #10 certificate request, that is to say certificationRequestInfo, is signed.
   According to embodiments of the invention, the second control algorithm with its parameters is entered in the “signatureAlgorithm” field, which serves as the second field 440.
iii. Signature: corresponds to the signatureValue field 706 and contains the value of the signature.
   According to embodiments of the invention, the “signature” field of the certificate request, which is the first field 438, stores the composite cryptographic data, i.e. the signature formed according to the algorithm denoted in i).

The content of the PKCS #10 certificate request is certificationRequestInfo and is defined according to RFC 2986 as

| CertificationRequestInfo ::= SEQUENCE { | |
|---|---|
| version | INTEGER { v1(0) } (v1,...), |
| subject | Name, |
| subjectPKInfo SubjectPublicKeyInfo{{ PKInfoAlgorithms }}, | |
| attributes | [0] Attributes{{ CRIAttributes }} |
| } | |

iv. subjectPKInfo: corresponds to the certificate area SubjectPublicKeyInfo 708. This certificate area contains, according to the use provided for in the prior art so far, a public key that is to be contained in the X.509 certificate of the applicant. The identifiers of the first and second fields correspond to the identifiers described for certificate area 708 of X.509 certificates (see in particular RFC 5280, which refers to subjectPublicKeyInfo in certificates, and RFC 2986, which refers to the subjectPKInfo field in PKCS #10) and contain the same type definition SubjectPublicKeyInfo as cited on page 74) According to embodiments of the invention, subjectPKInfo is an area of a data structure 234 consisting of a first field 438 and a second field 440. The second field contains the ID of the control algorithm (for example KEY CONTAINER) and as parameters the algorithm designators of the various keys contained in the first field as concatenation.

d) Revocation Lists (CRL)

Revocation lists are secured against falsification by signatures. The formal syntax is

```
CertificateList ::= SEQUENCE {
  tbsCertList TBSCertList,
  signatureAlgorithm AlgorithmIdentifier,
  signatureValue BIT STRING }
```

Thus, by default (for example according to RFC 5280: Internet X.509 Public Key Infrastructure Certificate and Certificate Revocation List (CRL) Profile, May 2008) a revocation list contains the “signatureAlgorithm” field, which is used as the “second field” 440, and the “signature Value” field, which is used as the “first field” 438.

According to embodiments of the invention, the data structure is a revocation list in which the identifier of the second control algorithm is stored in the “signatureAlgorithm” field, wherein the “signatureValue” field, in which the bit sequence of the individual algorithm signature is normally stored, stores the composite cryptographic data according to embodiments of the invention. Thus, the “signatureAlgorithm” field serves here as the “second field” 440 for storing the identifier of the second control algorithm as well as the composite parameters, and the “signature Value” field serves as the “first field” 438 for storing the associated composite cryptographic data.

e) Validity Statements for Certificates According to OCSP

The validity statements for certificates according to the OCSP standard (RFC 6990: X.509 Internet Public Key Infrastructure—Online Certificate Status Protocol—OCSP, June 2013) are signed. The formal syntax for the signed part of the information is:

BasicOCSPResponse ::= SEQUENCE {
tbsResponseData ResponseData,
signatureAlgorithm AlgorithmIdentifier,
signature BIT STRING,
certs [0] EXPLICIT SEQUENCE OF Certificate OPTIONAL }

According to embodiments of the invention, the data structure is a certificate validity statement, wherein the “signatureAlgorithm” field stores the identifier of the second control algorithm, and the “signature” field stores the composite cryptographic data, preferably a composite cryptographic signature.

In this data structure there is also a predefined field for an algorithm identifier and another field for a signature value. Thus, the “signatureAlgorithm” field serves here as the “second field” 440 for storing the identifier of the second control algorithm as well as the composite parameters, and the “signature” field serves as the “first field” 438 for storing the associated composite cryptographic data.

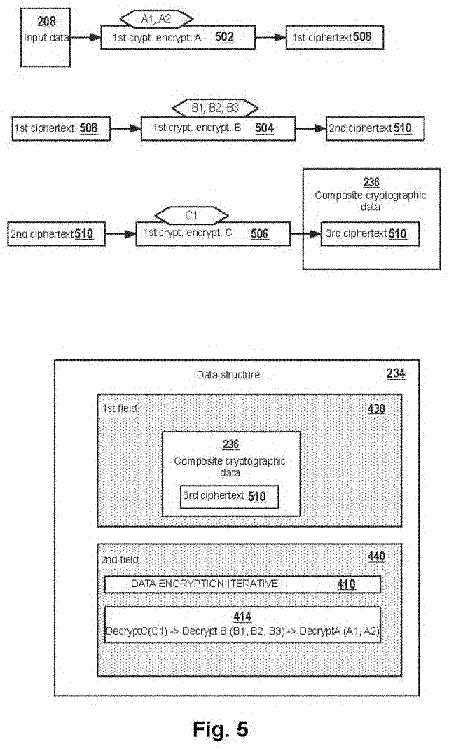

FIG. 5 shows a schema of the application of another first control algorithm and a data structure with the composite cryptographic data generated according to it.

While FIG. 4 illustrates the parallel application of a plurality of first cryptographic algorithms to the input data 208, FIG. 5 shows the sequential (iterative) application of a plurality of first algorithms to the input data. Here, a first cryptographic algorithm A 502 is first applied directly to the input data 208 to generate a first ciphertext 508. This in turn serves as input for a second cryptographic algorithm B 504, which encrypts the ciphertext 508 to generate a further ciphertext 510. The procedure may be applied iteratively a number of times until the last-applied algorithm outputs a ciphertext 510 which is used as composite cryptographic data.

With iterative application of the first cryptographic algorithms, the second control algorithm is typically not of the “OR” type, since all second cryptographic algorithms that are complementary to the iteratively applied first cryptographic algorithms must be applied to reconstruct the input data. If even one of these second cryptographic algorithms is missing from the chain, the procedure is unable to be performed. Nevertheless, an iterative application of first cryptographic algorithms may also be helpful in the context of moving to quantum-computer-secure methods. For example, the three encryption algorithms applied first could be conventional, non-quantum-secure encryption procedures. The very fact that a plurality of methods are used increases security. For example, the provider cryptosystem may use these three encryption procedures to provide a composite ciphertext for a receiver cryptosystem that has not yet been converted. If the provider cryptosystem also has additionally a further quantum-computer-secure encryption algorithm, it may include a further first control algorithm that provides a fourth level of encryption using the quantum-computer-secure encryption algorithm. This composite ciphertext generated in four iterative encryption steps may be sent to another receiver cryptosystem that has four complementary decryption procedures including a quantum-computer-secure decryption procedure.

The ciphertext 510 represents the composite cryptographic data or a component thereof and is stored in a first field 438 of a predefined data structure 234, in which cryptographic data of an individual cryptographic algorithm are stored by default. The identifier 410 of the “DATA ENCRYPTION ITERATIVE” control algorithm as well as associated parameters, in particular the algorithm designators of the functionally complementary decryption algorithms C, B and A with the required component parameters 414 are stored in a second field 440 of this data structure, in which identifiers and parameters of an individual cryptographic algorithm are normally stored. Since the receiver cryptosystem has immediate access to the algorithm designators of all algorithms A, B, C required for decryption in the second field 440, it may decide not to perform decryption and the corresponding second control algorithm from the outset if it does not support at least one of the required second cryptographic algorithms.

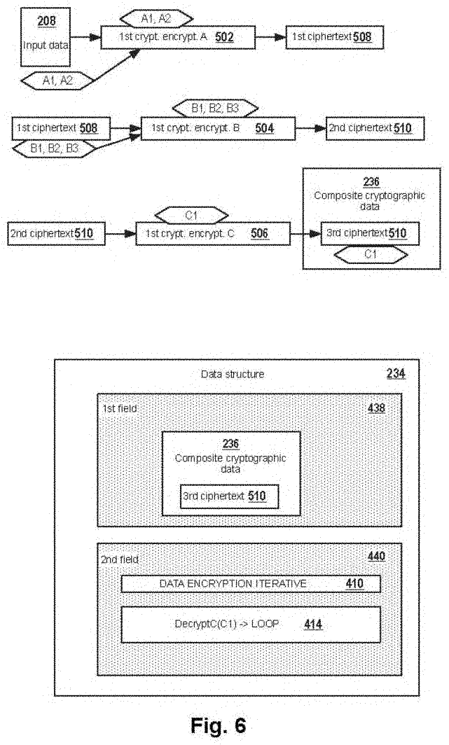

FIG. 6 shows a schema of the application of a further first control algorithm and a data structure with the composite cryptographic data generated according to it. The application of this first control algorithm is similar to the algorithm described for FIG. 5, except that the component parameters of the various encryption algorithms are used as input, together with the ciphertext previously computed, to compute the ciphertext of the next step in the sequence. In this case, only algorithm designators and component parameters of the most recently executed encryption algorithm 506 C or of the decryption algorithm to be executed first need to be provided to the receiver cryptosystem as parameters in plain text together with the composite cryptographic data 236, and the algorithm designators and component parameters of the other encryption and decryption algorithms B, A, respectively, are obtained during the decryption. However, in this embodiment, the receiver cryptosystem is unable to immediately determine whether it supports all of the required second cryptographic algorithms, and so the embodiments shown according to FIG. 5 are preferred.

FIG. 7 shows an exemplary X.509 certificate containing composite cryptographic data and associated parameters from two different control algorithms stored in specific fields (see the description of FIG. 4).

### LIST OF REFERENCE SIGNS

102-112 steps
200 provider cryptosystem
202 processor(s)
204 storage medium
206 first application program
208 input data
210 interface
212 first cryptographic program
214-224 first cryptographic algorithms
226 computing module
228-232 first control algorithms
234 data structure
236 composite cryptographic data
240 receiver cryptosystem
242 storage medium, archive
302 processor(s)
304 storage medium
306 second application program
308 results data
310 software/hardware function
312 second cryptographic program
314-324 second cryptographic algorithms
326 computing module
328-332 second control algorithms
402 identifier of the first control algorithm
404 parameters of the first control algorithm
408 algorithm designators and component parameters of the first cryptographic algorithms
410 identifier of the second control algorithm
412 parameters of the second control algorithm
414 parameters of the second control algorithm
416 algorithm designators and component parameters of the second cryptographic algorithms
418 signature generated by signature algorithm 216
420 signature generated by signature algorithm 218
422 signature generated by signature algorithm 220
438 first field
440 second field
502 encryption algorithm A
504 encryption algorithm B
506 encryption algorithm C
700 data structure
702 signatureAlgorithm field (second field with identifier and parameters)
704 signature field (second field with identifier and parameters)
706 signatureValue field (first field with composite crypt. data)
708 subjectPublicKeyInfo area (contains a first and second field)

1. A method for exchanging data between a provider cryptosystem and a receiver cryptosystem, the method comprising the steps of:
computing composite cryptographic data by executing a plurality of first cryptographic algorithms, wherein the composite cryptographic data are computed as a function of input data, wherein the plurality of first cryptographic algorithms are selected and/or the plurality of first cryptographic algorithms are combined according to a first control algorithm;
providing the composite cryptographic data from the provider cryptosystem to the receiver cryptosystem;
computing results data using the receiver cryptosystem as a function of the composite cryptographic data by applying one or more of the second cryptographic algorithms, wherein the one or more second cryptographic algorithms are selected and/or combined according to a second control algorithm; and
automatically executing a software and/or hardware function using the receiver cryptosystem according to the result data.

2. (canceled)

3. The computer-implemented method according to claim 1,
wherein the provider cryptosystem implements a plurality of first control algorithms; and/or
wherein the receiver cryptosystem implements a plurality of second control algorithms.

4. The computer-implemented method according to claim 1,
wherein at least one of the first cryptographic algorithms is an encryption,
signing, or key agreement algorithm, and wherein at least one of the one or more second cryptographic algorithms is a decryption, signature verification, and key agreement algorithm complementary to the at least one first cryptographic algorithm.

5. The computer-implemented method according to claim 1,
wherein the first control algorithm specifies that the plurality of first cryptographic algorithms are sequentially applied to the output of the previously executed first cryptographic algorithm, or that the plurality of first cryptographic algorithms are applied in parallel to the input data or parts of the input data; and/or
wherein the second control algorithm specifies that the plurality of second cryptographic algorithms are sequentially applied to the output of the previously executed second cryptographic algorithm, or that the plurality of second cryptographic algorithms are applied in parallel to the composite cryptographic data or parts of the composite cryptographic data.

6. The computer-implemented method according to claim 1,
wherein at least the first control algorithm contains Boolean operators and/or arithmetic operators connecting a plurality of the first cryptographic algorithms to one another, wherein the operators specify how to combine the cryptographic data output by the individual first cryptographic algorithms to obtain the composite cryptographic data, and/or wherein the second control algorithm contains Boolean operators and/or arithmetic operators which connect a plurality of the second cryptographic algorithms to one another such that their combined application to the transmitted composite cryptographic data and/or to an output of a previously executed second cryptographic algorithm results in data processing functionally complementary to the execution of the first cryptographic algorithms.

7. The computer-implemented method according to claim 1, wherein the first and/or second control algorithm have an identifier selected from a group comprising:
“SIGNATURE AND”,
wherein the SIGNATURE AND identifier identifies a first control algorithm of the provider cryptosystem specifying to compute a signature by means of one or more first cryptographic algorithms each implementing a signature algorithm;
wherein the SIGNATURE AND identifier identifies a second control algorithm of the receiver cryptosystem specifying to verify, by means of one or more second cryptographic algorithms each implementing a signature verification algorithm, a signature created by means of a signature algorithm corresponding to the signature verification algorithm, wherein the second control algorithm specifies that the results data are computed such that they confirm the integrity and/or authenticity of the composite cryptographic data precisely when all signature checks performed by the signature verification algorithms show that the verified signature is valid;
“SIGNATURE OR”,
wherein the SIGNATURE OR identifier identifies a first control algorithm of the provider cryptosystem specifying to compute a signature by means of one or more first cryptographic algorithms each implementing a signature algorithm;
wherein the SIGNATURE OR identifier identifies a second control algorithm of the receiver cryptosystem specifying to verify, by means of one or more second cryptographic algorithms each implementing a signature verification algorithm, a signature created by means of a signature algorithm corresponding to the signature verification algorithm, at least until at least one of the signature verification algorithms concludes that the signature is valid or until all signature verification algorithms of the receiver cryptosystem have been executed, wherein the results data are computed such that they confirm the integrity and/or authenticity of the composite cryptographic data precisely when at least one of the signature verification algorithms has concluded that the verified signature is valid;
“SIGNATURE K-of-N”,
wherein the SIGNATURE K-of-N identifier identifies a first control algorithm of the provider cryptosystem specifying to compute a signature by means of one or more first cryptographic algorithms each implementing a signature algorithm;
wherein the SIGNATURE K-of-N identifies a second control algorithm of the receiver cryptosystem specifying to verify, by means of K cryptographic algorithms each implementing a signature verification algorithm, a signature created by means of a corresponding signature algorithm, at least until at least K of the signature verification algorithms conclude that the verified signature is valid or until all signature verification algorithms have been executed, wherein the results data are computed such that they confirm the integrity and/or authenticity of the composite cryptographic data precisely when at least K of the signature verification algorithms have concluded that the verified signature is valid, wherein K is a number greater than 0, preferably greater than 1;
“KEY AGREEMENT AGGREGATE”,
wherein the KEY AGREEMENT AGGREGATE identifier identifies a first control algorithm of the provider cryptosystem specifying to compute a cryptographic key by means of one or more first cryptographic algorithms each implementing provider-side key agreement steps according to a particular key agreement procedure, and to compute a final key by aggregation of all these keys;
wherein the KEY AGREEMENT AGGREGATE identifier identifies a second control algorithm of the receiver cryptosystem specifying to compute a cryptographic key by means of one or more second cryptographic algorithms each implementing receiver-side steps of a key agreement procedure, and to compute a final key by aggregation of all these keys;
DATA ENCRYPTION-ITERATIVE,
wherein the DATA ENCRYPTION ITERATIVE identifier identifies a first control algorithm of the provider cryptosystem specifying to compute, by means of one or more first cryptographic algorithms each implementing an encryption algorithm, a ciphertext according to a particular encryption procedure, wherein the encryption algorithms are executed sequentially, wherein the first executed encryption algorithm uses the input data as input and all subsequently executed encryption algorithms use the ciphertext generated by the previously executed encryption algorithm as input;
wherein the DATA ENCRYPTION ITERATIVE identifier identifies a second control algorithm of the receiver cryptosystem specifying to decrypt, by means of one or more second cryptographic algorithms each implementing a decryption algorithm, a ciphertext according to a particular decryption procedure to obtain decrypted data, wherein the decryption algorithms are executed sequentially, wherein the first executed decryption algorithm uses as input the ciphertext provided by the provider computer system and all subsequently executed encryption algorithms use the decrypted data generated by the previously executed decryption algorithm as input;
DATA ENCRYPTION PARALLEL,
wherein the DATA ENCRYPTION PARALLEL identifies a first control algorithm of the provider cryptosystem specifying to compute, by means of one or more first cryptographic algorithms each implementing an encryption algorithm, a ciphertext according to a particular encryption procedure, wherein each of the encryption algorithms uses the input data or portions thereof as input;
wherein the DATA ENCRYPTION PARALLEL identifies a second control algorithm of the receiver cryptosystem specifying to decrypt, by means of one or more second cryptographic algorithms each implementing a decryption algorithm, a ciphertext according to a particular decryption procedure to obtain decrypted data, wherein each of the decryption algorithms uses the ciphertext provided by the provider computer system as input;
“KEY CONTAINER”,
wherein the KEY CONTAINER identifier identifies a first control algorithm of the provider cryptosystem specifying to compute a composite cryptographic key by means of one or more first cryptographic algorithms which each designate a key and/or are generated from at least parts of the input data, wherein the composite cryptographic key is used as the composite cryptographic data;
wherein the KEY CONTAINER identifier identifies a second control algorithm of the receiver cryptosystem specifying, by means of one or more second cryptographic algorithms, extracting and/or using individual keys from the composite cryptographic key.

8. The computer-implemented method according to claim 1, wherein the composite cryptographic data contain parameters and/or are provided together with the parameters, wherein the parameters contain algorithm designators of the cryptographic procedure implemented by the executed first cryptographic algorithm, and optionally component parameters of these cryptographic procedures and/or optionally control parameters for the second control algorithm, wherein the method preferably further comprises the steps of:
identifying, by the receiver cryptosystem, each of the second cryptographic algorithms used for the computation of the results data within a plurality of second cryptographic algorithms, prior to or during the computation of the results data by means of the algorithm designators, wherein each of the identified second cryptographic algorithms implements receiver-system-side steps of the same cryptographic method as a first cryptographic algorithm corresponding thereto.

9. The computer-implemented method according to one of the claim 1,
wherein providing the composite cryptographic data comprises storing the composite cryptographic data in a single first predefined field of a data structure agreed between the provider cryptosystem and the receiver cryptosystem,
wherein the receiver cryptosystem is configured to read and parse the first predefined field of the data structure to obtain the composite cryptographic data.

10. The computer-implemented method of claim 9, further comprising the steps of:
storing an identifier of the second control algorithm and optionally one or more parameters in a second predefined field of the data structure by the provider cryptosystem; and
reading and parsing, by the receiver cryptosystem, of the identifier of the second control algorithm from the second predefined field of the data structure; and
selecting the second control algorithm on the basis of the read identifier by the receiver cryptosystem.

11. The computer-implemented method according to claim 10, wherein the agreed data structure is selected from a group comprising:
a certificate, in particular an X.509 certificate;
a CV certificate (Card Verifiable certificate);
a file signature or an encrypted file, in particular a file signature or an encrypted file according to the Cryptographic Message Syntax (CMS) standard,
a certificate request, in particular a certificate request according to RFC 2986: PKCS #10;
a revocation list, in particular a Certificate Revocation List (CRL) according to RFC 5280;
a validity statement for certificates, in particular a validity statement according to the Online Certificate Status Protocol—OCSP.

12. The computer-implemented method according to claim 9,
wherein the first field is a field intended for storing, according to a cryptographic standard, the cryptographic data generated by a single cryptographic algorithm; and/or
wherein the second field is a field intended for storing, according to a cryptographic standard, the algorithm designator of a single cryptographic algorithm.

13. The computer-implemented method according to claim 1,
wherein the plurality of first cryptographic algorithms comprise a plurality of cryptographic signature algorithms according to a plurality of different signing procedures;
wherein the second cryptographic algorithms comprise a plurality of cryptographic signature verification algorithms each implemented according to one of the different signing procedures.

14. The computer-implemented method according to claim 1,
wherein the plurality of first cryptographic algorithms comprise a plurality of cryptographic encryption algorithms according to a plurality of different encryption procedures;
wherein the plurality of second cryptographic algorithms comprise a plurality of cryptographic decryption algorithms corresponding to the plurality of different encryption procedures.

15. The computer-implemented method according to claim 1,
wherein the plurality of first cryptographic algorithms comprise a plurality of provider-side key agreement algorithms according to a plurality of different key agreement procedures;
wherein the second cryptographic algorithms comprise a plurality of receiver-side key agreement algorithms, each implemented corresponding to one of the different key agreement procedures.

16. The computer-implemented method according to claim 1, further comprising the steps of:
providing a template of the second control algorithm by the receiver cryptosystem, wherein the template specifies whether the second cryptographic algorithms are to be applied in series or in parallel and specifies how the outputs of the second cryptographic algorithms are combined to obtain the composite cryptographic data; and
in response to the receipt, by the receiver cryptosystem, of the composite cryptographic data and parameters associated therewith, generating the second control algorithm by supplementing the template with the algorithm designators of the second control algorithms contained in the parameters, wherein the second cryptographic algorithms selected and/or combined by the second control algorithm are selected on the basis of these algorithm designators.

17. The computer-implemented method according to claim 1, wherein the input data (208) include a text, a parameter of a cryptographic method, and/or a cryptographic key.

18. A provider cryptosystem comprising:
a volatile or non-volatile storage medium comprising a plurality of first cryptographic algorithms and at least one first control algorithm, wherein a first control algorithm is a computational rule for selecting and/or combining two or more of the first cryptographic algorithms;
at least one processor configured to:
generate input data;
compute composite cryptographic data by executing a plurality of the first cryptographic algorithms, wherein the composite cryptographic data are computed as a function of the input data, wherein the plurality of first cryptographic algorithms and/or a combination of the plurality of first cryptographic algorithms are selected according to the at least one first control algorithm;
provide the composite cryptographic data from the provider cryptosystem to the receiver cryptosystem.

19. The provider cryptosystem according to claim 18, further comprising:
a first cryptographic application including the first cryptographic algorithms and the first control algorithms; and
a first application program which is free of cryptographic algorithms and which is interoperable with the first cryptographic application and configured to:
provide the input data to the first cryptographic application and/or cause the first cryptographic application to generate the input data;
cause the first cryptographic application to compute and return the composite cryptographic data to the first application program;
store the composite cryptographic data in a first predefined field of a data structure agreed between the provider cryptosystem and the receiver cryptosystem; and
send the data structure to the receiver cryptosystem.

20. A receiver cryptosystem comprising:
a volatile or non-volatile storage medium comprising one or more second cryptographic algorithms and at least one second control algorithm, wherein a second control algorithm is a computational rule for selecting and/or combining one or more of the second cryptographic algorithms;
at least one processor configured to:
receive composite cryptographic data from the provider cryptosystem;
compute results data as a function of the composite cryptographic data by applying one or more of the second cryptographic algorithms, wherein the one or more second cryptographic algorithms are selected and/or combined according to one of the second control algorithms; and
automatically execute a software and/or hardware function depending on the results data.

21. The receiver cryptosystem according to claim 20, further comprising:
a second cryptographic application containing the second cryptographic algorithms and the second control algorithms; and
a second application program which is free of cryptographic algorithms and which is interoperable with the second cryptographic application and configured to:
receive a data structure agreed between the provider cryptosystem and the receiver cryptosystem;
parse the data structure to read the composite cryptographic data from a first predefined field in the data structure;
provide the read composite cryptographic data to the second cryptographic application;
cause the second cryptographic application to compute and return to the second application program the results data as a function of the composite cryptographic data; and
cause the automatic execution of the software and/or hardware function depending on the results data.

22.-30. (canceled)
